(19) United States
(12) Patent Application Publication
(10) Pub. No.: US 2025/0210734 A1
(43) Pub. Date: Jun. 26, 2025

(54) INTELLIGENT BATTERY SYSTEMS, COMPONENTS FOR INTELLIGENT BATTERY SYSTEMS, METHODS OF MANUFACTURING AND OPERATING INTELLIGENT BATTERY SYSTEMS AND COMPONENTS OF THE SAME

(71) Applicant: CPS Technology Holdings LLC, New York, NY (US)

(72) Inventors: Jason D. Fuhr, Sussex, WI (US); Arunraj Varatharajah, Menomonee Falls, WI (US); Rengaraj Balakrishnan, Cary, NC (US); Tyler Thiel, Milwaukee, WI (US)

(21) Appl. No.: 18/851,990

(22) PCT Filed: Apr. 14, 2023
(86) PCT No.: PCT/US2023/018727

§ 371 Date: Sep. 27, 2024

Related U.S. Application Data
(60) Provisional application No. 63/331,211, filed on Apr. 14, 2022.

(51) Int. Cl. H01M 10/42; H01M 10/06; H01M 50/204; H01M 50/289; H01M 50/552; H01M 50/569

(52) U.S. Cl. CPC H01M 10/4257; H01M 10/06; H01M 50/289; H01M 50/561; H01M 50/569; H01M 2010/4271; H01M 50/204

(57) ABSTRACT

Disclosed is a lead assembly for a battery system, a battery or battery system having the lead assembly, and a method of manufacturing or assembling the lead assembly, the battery, or battery system. The battery system can be a lead-acid battery system having multiple compartments. A first compartment can be a battery cells compartment and a second compartment can be a battery monitoring system (BMS) compartment. In an embodiment, multiple posts extend through bushings from the first compartment to the second compartment. A lead assembly couples the posts to the BMS. Also disclosed are various bushing designs, and various programmable circuit designs and arrangements.

### RELATED APPLICATION

This application claims priority to and the benefit of U.S. Patent Application No. 63/331,211; filed Apr. 14, 2022; entitled, “INTELLIGENT LEAD-ACID BATTERY SYSTEM AND METHOD OF OPERATING THE SAME”, the entire content of which is incorporated herein by reference.

### FIELD OF THE DISCLOSURE

This disclosure relates to lead-acid batteries. An example lead-acid battery is an absorbent glass mat (AGM) battery.

The disclosure relates to a lead assembly for a battery system, such as a lead-acid battery system. The disclosure also relates to a battery system having the lead assembly. The disclosure further relates to a method of manufacturing the battery system having the lead assembly.

The disclosure relates to a lead-acid battery system having a temperature sensor. The disclosure also relates to a circuit board assembly for a lead-acid battery system having the temperature sensor. The disclosure further relates to a method of manufacturing a family of lead-acid battery systems having the circuit board assembly.

The disclosure relates to a bushing for a battery, such as a lead-acid battery. The disclosure also relates to a battery including the bushing. The disclosure further relates to a method of manufacturing the battery system including the bushing.

The disclosure relates to a lead-acid battery system having a multi-compartment housing.

### BACKGROUND

One example environment for a lead-acid battery is a vehicle. A conventional vehicle with a conventional internal combustion engine (ICE) might include, for example, a traditional flooded lead-acid battery. A vehicle with a conventional ICE or a start-stop system or a mild-hybrid engine might include a traditional AGM lead-acid battery. Some vehicles, such as some mild-hybrid engine vehicles, may also include non-lead-acid batteries. Other vehicle types and battery arrangements are known. However, as vehicles become more automated or autonomous, and as vehicles become more electric, battery intelligence, reliability, and performance need to increase.

For some environments, detecting individual cell health and/or deterioration of a lead-acid battery can enable a user to detect a potential battery failure more quickly. This would allow the user more time to replace the lead-acid battery before failure. Thus, in embodiments, an intelligent (or “smart”) lead-acid battery can monitor a parameter associated with a cell of a lead-acid battery. Also, an intelligent lead-acid battery can monitor other parameters, e.g., battery temperature, cell temperature, compartment temperature, etc., that traditional lead-acid batteries do not monitor.

### SUMMARY

Disclosed herein are intelligent (or “smart”) lead-acid battery systems and improvements thereto. An example intelligent lead-acid battery is an intelligent or “smart” absorbent glass mat (AGM) solution. An intelligent AGM battery system includes sensor technology not normally associated with traditional lead-acid batteries. Without limitation, the additional sensed parameters can improve predictions of the battery's state of health, state of charge, state of function, life expectancy, charging and discharging capability, etc. An intelligent battery system can understand the battery's status, which can allow for modification of the charging/discharging of the battery system and/or operation of the vehicle or environment that the battery system is placed. In some embodiments, cell voltage monitoring allows better charging management to ensure battery is neither undercharged nor overcharged. Example parameters sensed by the intelligent battery system can include one or more of the following: battery voltage, battery current, cell voltage, cell current, partial battery voltage, partial battery current, battery temperature, cell temperature, ambient or environment temperature, compartment temperature, battery pressure, cell pressure, cell state of charge, battery state of charge, etc.

In at least one example lead-acid battery system described herein, the battery system includes a housing defining at least in part multiple compartments. A first compartment may be referred to as a “cells” compartment, and a second compartment may be referred to as a “battery monitoring system” (BMS) compartment. The housing can include a wall disposed between the cells compartment and the BMS compartment. The wall can be a cover for the cells compartment and a base for the BMS compartment. A plurality of battery cells is housed in the cells compartment. The plurality of battery cell has a plurality of posts. A first post and a second post protrude through the wall from the cells compartment to the BMS compartment. The BMS is housed by the BMS compartment. The BMS includes a voltage sensor electrically coupled to the first post and the second post and can sense a voltage less than the battery voltage. An example of a voltage less than the battery voltage is a cell voltage. Another example of a voltage less than the battery voltage is a voltage for a plurality of cells (e.g., 2 cells) but not the total voltage for the plurality of cells (e.g., 6 cells if the battery system consists of 6 cells).

In one or more embodiments, multiple smaller (or “mini”) posts, as compared to conventional terminal posts, are positioned on straps of the battery cells. The strap posts may be operable to measure a voltage, such as a voltage for an individual battery cell. The strap posts extend through a battery housing cover and into the BMS compartment. A temperature sensor can also be thermally coupled to one of the strap posts. The temperature sensor can sense a temperature associated with a cell, i.e., a cell temperature or a cells compartment temperature.

In one embodiment, the disclosure provides a lead assembly for a battery comprising a plurality of battery cells and a battery monitoring system. The lead assembly includes a plurality of leads, and a plurality of support connectors. Each lead of the plurality of leads has a conductive path with a first end and a second end opposite to the first end. Each first end comprises a first connector, and each second end comprises a second connector. The first connector is couplable to a battery cell and the second connector is couplable to the battery monitoring system. Each support connector of the plurality of support connectors couples one lead of the plurality of leads with an adjacent lead of the plurality of leads.

In other embodiments, the disclosure provides a battery including the lead assembly and a method of assembling a battery. The method includes providing the lead assembly as a lead skeleton, and enclosing a portion of the lead skeleton with a lead body. The lead body includes a plurality of apertures. The plurality of apertures includes an aperture corresponding to a respective support connector of the plurality of support connectors. The aperture exposes at least a portion of the respective support connector from the lead body. The method further includes breaking at least a portion of the plurality of support connectors in the plurality of apertures.

In another embodiment, the disclosure provides a lead assembly including a plurality of leads, a lead body enclosing a portion of each of the plurality of leads. Each lead of the plurality of leads has a conductive path with a first end and a second end opposite to the first end. Each first end includes a first connector. Each second end includes a second connector. The first connector is couplable to a battery cell and the second connector is couplable to the battery monitoring system. The conductive path of at least one lead extends in a first respective direction in a first plane, the conductive path of the at least one lead includes an intermediate conductive path having a bend changing the conductive path from the first respective direction to a respective intermediate direction. The conductive path extends in the intermediate conductive direction. The intermediate conductive path has a bend changing the conductive path from the respective intermediate direction to a respective second direction. The conductive path extends in the respective second direction. The respective second direction is the same as the respective first direction and being in a second plane different from the first plane.

In yet another embodiment, the disclosure provides a battery including the lead assembly and a method of assembling a battery. The method includes providing the lead assembly as a lead skeleton, enclosing a portion of the lead skeleton with a lead body, flexing the plurality of leads to couple to a post and a bushing, and welding the plurality of leads to the post and the bushing.

In a further embodiment, the disclosure provides a battery system comprising a plurality of battery cells, a plurality of connecting straps coupling the plurality of battery cells, a first end strap coupling one of the plurality of battery cells to a first terminal, a second end strap coupling another of the plurality of battery cells to a second terminal, and a housing comprising a base and a first cover sealed to the base. Each connecting strap plurality of connecting straps has a mini post coupled thereto. The base and the first cover define a battery cells compartment housing the plurality of battery cells. The first cover comprises a first plurality of openings. Each opening of the first plurality of openings receives a respective mini post, the first terminal, or the second terminal.

In yet a further embodiment, the disclosure provides a battery comprising a plurality of battery cells. A post electrically coupled to at least one cell of the plurality of battery cells, a thermal conductor coupled to the post, and a circuit board assembly. The circuit board assembly includes a circuit board, a temperature sensor coupled to the circuit board and to the thermal conductor, and a processor and memory coupled to the circuit board and in thermal communication with the at least one cell via the temperature sensor, the thermal conductor, and the post. The memory includes instructions executable by the processor to monitor a cell temperature based on heat transfer sensed by the temperature sensor, and to control an operation of the battery based on the cell temperature.

In an embodiment, the disclosure provides a circuit board assembly for a battery system. The circuit board assembly includes a circuit board, such as a printed circuit board, a first temperature sensor coupled to the circuit board and to be in thermal communication with at least a second battery cell of the plurality of battery cells, a second temperature sensor coupled to the circuit board, a voltage sensor coupled to the circuit board and couplable to the at least one lead, and a processor and a memory supported by the circuit board and in communication the first temperature sensor, the second temperature sensor, and the voltage sensor. The memory includes instructions executable by the processor to determine a cell voltage value for the first battery cell, acquire a cell temperature value via the first temperature sensor, acquire an ambient temperature value via the second temperature sensor, and control an operation of the battery system with the cell voltage value, the cell temperature value, and the ambient temperature value.

In another embodiment, the disclosure provides a method of assembling a plurality of lead-acid battery systems with identical programmable circuit boards. Each identical programmable circuit board comprises a circuit board, a plurality of voltage sensors coupled to the circuit board, a first temperature sensor mounted to the circuit board at a first location, and a second temperature sensor mounted to the circuit board at a second location different from the first location. The plurality of lead-acid battery systems includes a first battery system with a first housing designation and a second battery system with a second housing designation. The method includes coupling a first programmable circuit board of the identical programmable circuit boards to the first battery system having the first housing designation, coupling a first lead assembly to the first programmable circuit board, the first lead assembly having a first configuration, coupling the first temperature sensor of the first programmable circuit board to a post of the first battery system, coupling a second programmable circuit board of the identical programmable circuit boards to a second battery system having the second housing designation, coupling a second lead assembly to the second programmable circuit boards, and coupling the second temperature sensor of the second programmable circuit board to a post of the second battery system. The second lead assembly has a second configuration different than the first configuration.

In a further embodiment, the disclosure provides a bushing for a receiving a post of a battery. The bushing is to be supported by a wall of the battery and has a body with a perimeter. The bushing includes an external surface in which the wall is fixable to, an internal surface in which the post can be received and extend through, a bottom surface, and a top surface. The bushing can be a mini bushing and the post can be a mini post. The bushing includes one or more of the following: a reservoir (or counterbore) surface between the top surface and the internal surface along the perimeter, a stepped surface between the top surface and the external surface along the perimeter, a fillet surface between the bottom surface and the internal surface along the perimeter. The bushing can also include an external surface having a labyrinth section. The labyrinth section can include a first arrow-like profile with a first point and a second arrow-like profile with a second point. In one or more embodiments, a first radius from the center axis to the first point is greater than a second radius from the center axis to the second point, where the radii are different.

In yet a further embodiment, the disclosure provides a battery system comprising a plurality of battery cells, a base, a first battery cover fixed to the base, the base and the first battery cover defining a cells compartment housing the plurality of battery cells, a battery monitoring system (BMS) supported by the first battery cover and configured to sense parameters of the plurality of battery cells, a platform integrally formed with the first battery cover, the platform including a shelf surface and a shelf wall, and a second battery cover fixed to the first battery cover at the shelf surface. The second battery cover has an inner surface near an outer surface of the shelf wall. The first battery cover and the second battery cover define a BMS compartment housing the BMS.

In an embodiment, the disclosure provides a method of assembling a battery with a mini bushing. The method includes providing the mini bushing, inserting a mini post through the mini bushing, heating the mini post, causing a portion of the mini post to deform to contact a surface of the mini bushing, placing a lead to a top surface of the mini bushing, heating the mini post, and causing the deformed portion to further deform to contact the lead.

These and other features, advantages, and embodiments of apparatus and methods according to this invention are described in, or are apparent from, the following detailed descriptions of various examples of embodiments.

### BRIEF DESCRIPTION OF THE DRAWINGS

FIG. 1 is an isometric view of a prior-art traditional lead-acid battery.

FIG. 2 is an isometric view of the lead-acid battery of FIG. 1 with the cover removed.

FIG. 3 is a partially exploded isometric view of the lead-acid battery of FIG. 1.

FIG. 4 is an isometric view of a prior-art vehicle having a battery system contributing all or a portion of the power for the vehicle.

FIG. 5 is an isometric view of an H3 lead-acid battery system incorporating aspects of the invention.

FIG. 6 is an isometric view of the battery system of FIG. 5 with a battery monitoring system (BMS) cover removed.

FIG. 7 is a top elevation view of the battery system of FIG. 6.

FIG. 8 is an isometric view of the battery system of FIG. 6 with the cells compartment cover removed.

FIG. 9 is an isometric view of an H6 lead-acid battery system incorporating aspects of the invention.

FIG. 10 is an isometric view of the battery system of FIG. 9 with a battery monitoring BMS cover removed.

FIG. 11 is a top elevation view of the battery system of FIG. 10.

FIG. 12 is an isometric view of the battery system of FIG. 10 with the cells housing cover removed.

FIG. 13 is an isometric view of a post assembly for the battery system of FIG. 5.

FIG. 14 is an isometric view of a cells compartment cover for the battery system of FIG. 5, the cells compartment cover including a plurality of bushings.

FIG. 15 is an isometric view of the cells compartment cover of FIG. 14 receiving posts from the post assembly of FIG. 13.

FIG. 16 is an isometric view of the main current path for the battery system of FIG. 5.

FIG. 17 is an isometric view of the main current path and a lead assembly for the battery system of FIG. 5.

FIG. 18 is an isometric view of the main current path, a lead assembly, and a circuit board assembly for the battery system of FIG. 5.

FIG. 19 is an isometric view of a cells compartment cover for the battery system of FIG. 9, the cells compartment cover including a plurality of bushings.

FIG. 20 is an isometric view of the cells compartment cover of FIG. 19 receiving posts from a post assembly of the battery system of FIG. 9.

FIG. 21 is an isometric view of the main current path for the battery system of FIG. 9.

FIG. 22 is an isometric view of the main current path and a lead assembly for the battery system of FIG. 9.

FIG. 23 is an isometric view of the main current path, a lead assembly, and a circuit board assembly for the battery system of FIG. 9.

FIG. 24 is a block diagram of the battery systems of FIG. 5, 9 having a BMS.

FIG. 25 is an isometric view of a lead skeleton for use with the battery system of FIG. 5.

FIG. 26 is an isometric view of a lead assembly for use with the battery system of FIG. 5, the lead assembly having structural elements.

FIG. 27 is an isometric view of the lead assembly of FIG. 26 with the structural elements broken.

FIG. 28 is an isometric view of the lead assembly of FIG. 27 coupled to bushings of the battery system of FIG. 5.

FIG. 29 is an isometric view of a lead skeleton for use with the battery system of FIG. 9.

FIG. 30 is a top elevation view of a lead assembly for use with the battery system of FIG. 9, the lead assembly having structural elements.

FIG. 31 is a top elevation view of the lead assembly of FIG. 30 with the structural elements broken.

FIG. 32 is an isometric view of the lead assembly of FIG. 31 coupled to bushings of the battery system of FIG. 9.

FIG. 33 is an isometric view of a bushing, and more particularly a mini bushing, used in the battery system of FIG. 5.

FIG. 34 is a side elevation view of the bushing of FIG. 33.

FIG. 35 is a top elevation view of the bushing of FIG. 33.

FIG. 36 is a bottom elevation view of the bushing of FIG. 33.

FIG. 37 is a sectional view along line 37-37′ of FIG. 34.

FIG. 38 is an isometric view of a bushing, and more particularly a mini bushing, used in the battery system of FIG. 9.

FIG. 39 is a side elevation view of the bushing of FIG. 38.

FIG. 40 is a top elevation view of the bushing of FIG. 38.

FIG. 41 is a bottom elevation view of the bushing of FIG. 38.

FIG. 42 is a sectional view along line 42-42 of FIG. 39.

FIGS. 43-47 represent a process of fixing a connector of a lead assembly to a mini terminal post and a mini bushing for the battery system of FIG. 9.

FIG. 48 is an isometric view of a circuit board assembly for use in the battery system of FIG. 5. FIG. 48 also shows two couplers of the main electrical bath shown in FIG. 16.

FIG. 49 is a top elevation view of the circuit and couplers of FIG. 48.

FIG. 50 is a bottom elevation view of the circuit and couplers of FIG. 48.

FIG. 51 is a side elevation view of the circuit board assembly thermally coupled to the bushing of FIG. 33 via a thermal coupler shown in phantom.

FIG. 52 is an isometric view of a circuit board assembly for use in the battery system of FIG. 9. FIG. 52 also shows two couplers of the main electrical bath shown in FIG. 21.

FIG. 53 is a top elevation view of the circuit and couplers of FIG. 52.

FIG. 54 is a bottom elevation view of the circuit and couplers of FIG. 52.

FIG. 55 is a side elevation view of the circuit board assembly thermally coupled to the of FIG. 38 via a thermal coupler shown in phantom.

FIG. 56 is a top elevation view of a circuit board schematic and possible locations for sensors in H3-H6 lead-acid batteries.

FIG. 57 is an enlarged side elevation view of a portion of one of the leads shown in FIG. 25.

FIG. 58 is an isometric view of a framed voltage harness connected to strap posts

FIG. 59 is a partial isometric view of a lead-acid battery system using the framed voltage harness of FIG. 58.

It should be understood that the drawings are not necessarily to scale. In certain instances, details that are not necessary to the understanding to the invention or render other details difficult to perceive may have been omitted. It should be understood, of course, that the invention is not necessarily limited to the apparatus or processes illustrated herein.

Within the scope of this application, it is expressly intended that the various aspects, embodiments, examples, and alternatives set out in the preceding paragraphs, the following description, the claims, and/or the drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### DETAILED DESCRIPTION

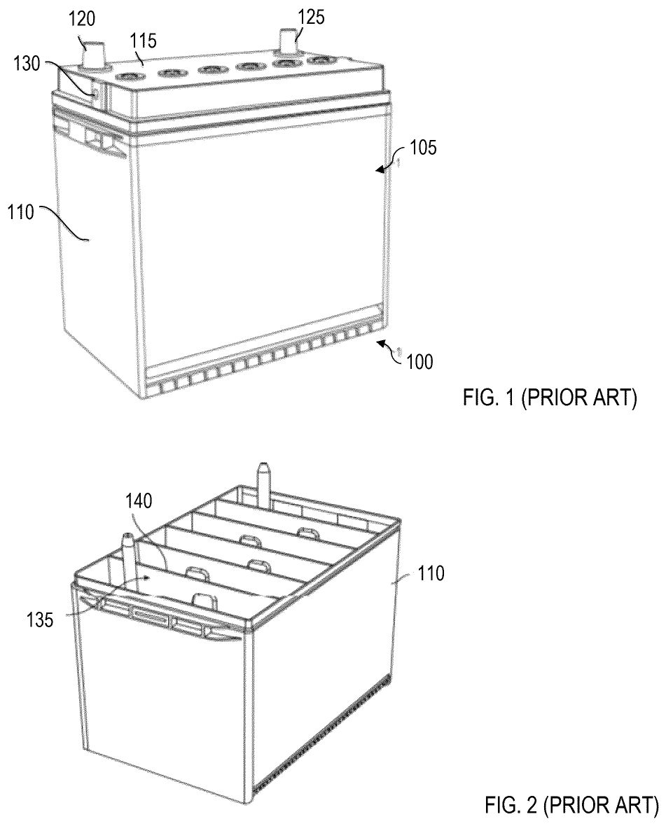

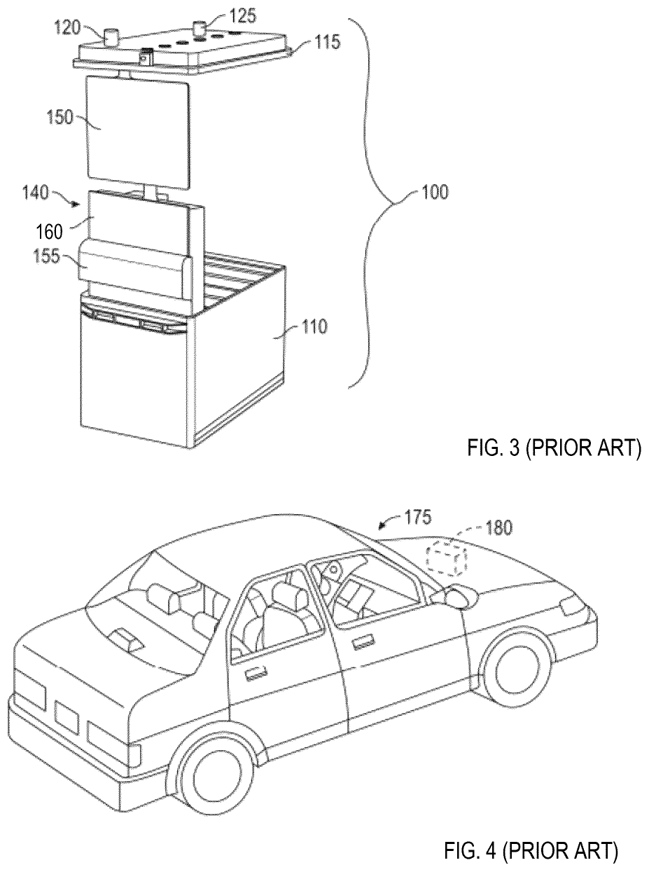

FIGS. 1-3 show a prior art absorbent glass mat (AGM) lead-acid battery 100 having a housing 105. The lead-acid battery 100 of FIGS. 1-3 is used for showing some of the underlying elements of a lead-acid battery and for providing background to the battery (or battery systems) and processes (or methods) described herein. It should be understood by one skilled in the art, however, that other styles of AGM lead-acid batteries (e.g., a cylindrical cell-type AGM lead-acid battery, bi-polar AGM battery, AGM batteries with differing cell numbers) and other types of lead-acid batteries (e.g., a non-AGM lead-acid battery, flooded and extended lead-acid batteries, gel-type battery) can be used with aspects of the invention. However, for ease of description, the disclosure herein will generally focus on the style of AGM lead-acid battery 100 shown in FIGS. 1-3. This includes variations of the AGM lead-acid battery systems described after FIG. 3.

With reference to FIG. 1, the housing 105 includes a base 110 and a cover 115. The cover 115 is secured to the base 110. An example means of securing is by heat sealing the cover 115 to the base 110. The battery 100 further includes terminals 120, 125 and a vent aperture 130 for venting gas from a venting system. The terminals protrude through or on the housing 105 (e.g., the cover 115 as shown). The terminals 120, 125 are provided on the cover 115 for connecting or coupling the battery 100 to electrical loads. Example electrical loads could include loads of a vehicle electrical system (discussed below).

FIG. 2 shows the cover 115 removed. The battery housing 105 supports a plurality of battery cell chambers (one chamber, 135, is labelled). The battery cell chambers can be formed by the housing 105 and a plurality of cell walls or partitions (one partition, 140, is labelled) that define the plurality of cell chambers. The partitions may be formed as being unitary with the housing 105. While the construction discussed herein has six cell chambers, a different number of chambers may be provided. Further, while the shown chambers are generally rectangular in shape, other shapes may be used for the chambers. The cell chambers (and related battery cells) may conventionally be referred to by number. For example, a six-cell battery would have cells 1, 2, 3, 4, 5, and 6. According to an example construction in which a battery is provided as having six cells, five partitions are provided.

FIG. 3 shows one of a plurality of battery cells in a partially exploded view. The battery cell 145 includes a plurality of positive frames or plates, a plurality of separators partially surrounding the positive plates, and a plurality of negative frames or plates. FIG. 3 has one positive frame or plate 150, one separator 155, and one negative frame or plate 160 labelled.

In some types of lead-acid batteries, the positive and negative plates each comprise a lead or lead-alloy grid that serves as a substrate and supports an electrochemically active material deposited or otherwise provided thereon during manufacture to form the battery plates. The grids provide an electrical contact between the positive and negative active materials or paste which serves to conduct current.

Separators are provided between the plates to prevent shorting and/or undesirable electron flow produced during the reaction occurring in the battery 100. Positive and negative electrode plates can be classified into various types according to the method of manufacturing. In one or more examples, each frame has a generally rectangular shape and includes a lug which is electrically coupled to the battery terminals 120, 125. The frame also may include side walls, a bottom edge, and opposing faces.

The one or more battery separators are used to insulatively separate the positive and negative electrodes. A separator material for an AGM lead-acid battery has sufficient porosity and retention to contain at least substantially all of the electrolyte necessary to support the electrochemical reactions. In various examples, the separator material is compressible so that upon stacking of the elements, the separator material substantially conforms to the contour of the surface of the plates to help it perform its wicking or capillary action.

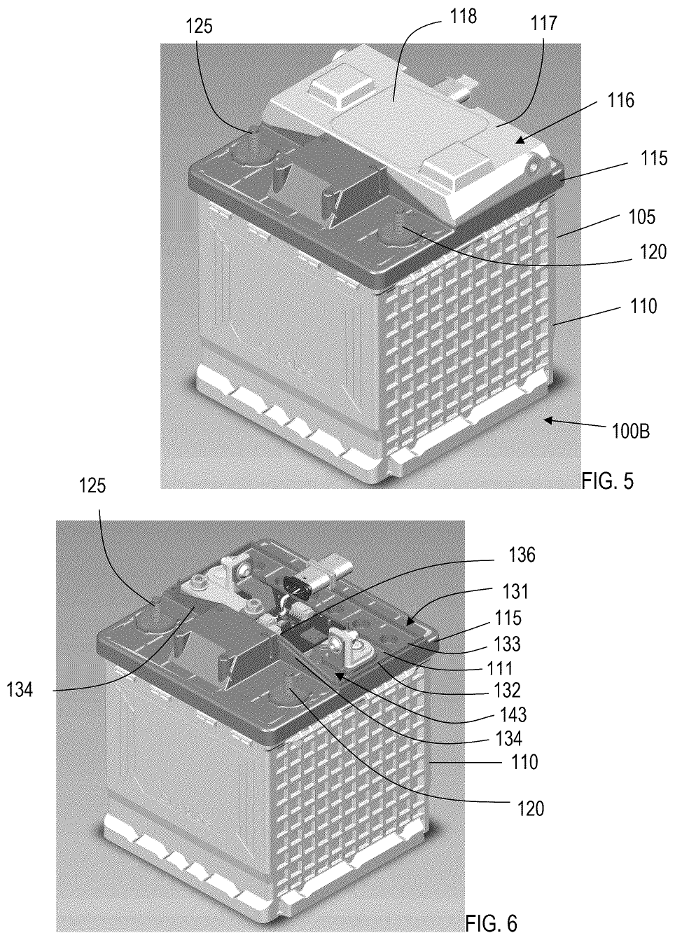

FIG. 4 is a perspective view of a prior art vehicle 175 having a battery system (represented by block 180). A vehicle (e.g., a petrol or gasoline vehicle, an electric vehicle, a hybrid vehicle) uses one or more batteries or battery systems. As will be appreciated by those skilled in the art, hybrid electric vehicles (HEVs) combine an internal combustion engine (ICE) propulsion system and a battery-powered electric propulsion system, such as 48 Volt (V) or 130V systems. Electric vehicles (EVs) are vehicles with no ICE. Each of these hybrid or full electric vehicles can be classified using the acronym xEV. Generally, the battery system 180 may capture/store electrical energy generated in or by the vehicle 175 and output electrical energy to power electrical devices in the vehicle 175. The battery system 180 may supply power to components of the vehicle's electrical system (e.g., a vehicle console, an ignition system, and an electric motor/generator).

The battery systems described herein may be used to provide power to various types of vehicles. The battery systems described herein may also be used to provide power to other energy storage/expending applications. Other example applications or environments include: starting, cycling, and powernet support applications; deep cycle primary power and motive power applications; and high rate and long duration reserve power applications. Example starting, cycling, and powernet support applications include: automotive; van and light duty commercial; heavy duty truck; bus and utility; agriculture; construction; marine; residential vehicle (RV); power sports including motorcycle, all-terrain vehicle (ATV), snowmobile, electric bicycle; genset; lawn and garden; rail; military, aerospace, and defense; etc. Example deep cycle primary power and motive power applications include: heavy duty load and lift gates; marine cycling; golf vehicles; motive such as forklift and guided vehicles; industrial such as scissor lift, scrubber, and pallet jack; wheelchairs; etc. Example high rate and long duration reserve power applications include: uninterruptable power source such as for a data center, critical power system, and emergency lighting; telecommunications such as wireline, wireless, broadband, and microwave; power generation and distribution, renewable energy; grid support including smart and distributed; safety, security, and traffic; etc. Such battery systems may include one or more batteries, each battery having a housing and a number of battery cells arranged within the housing, to provide particular voltages, currents, and/or power to the associated application.

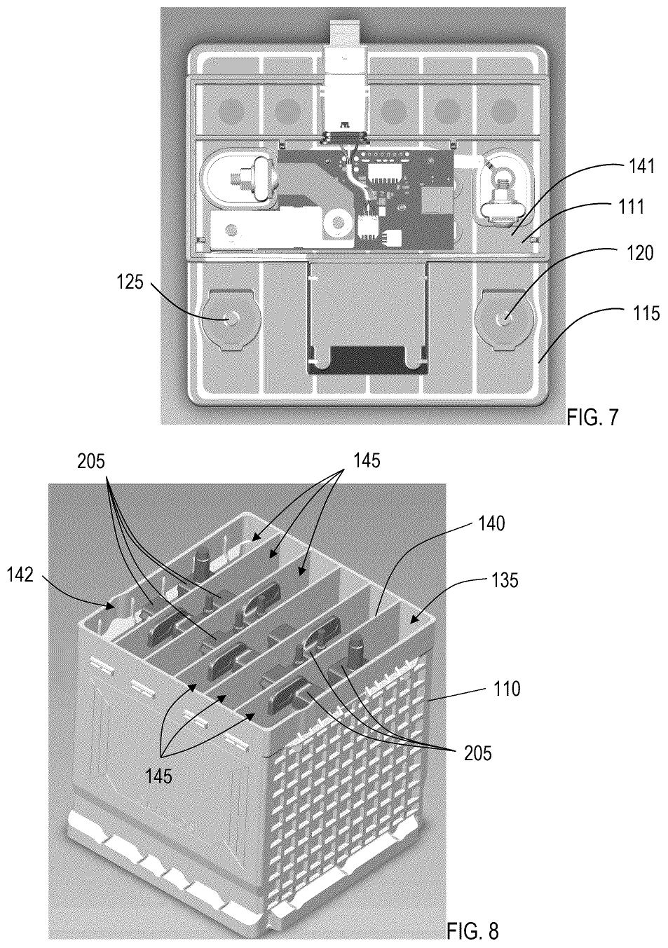

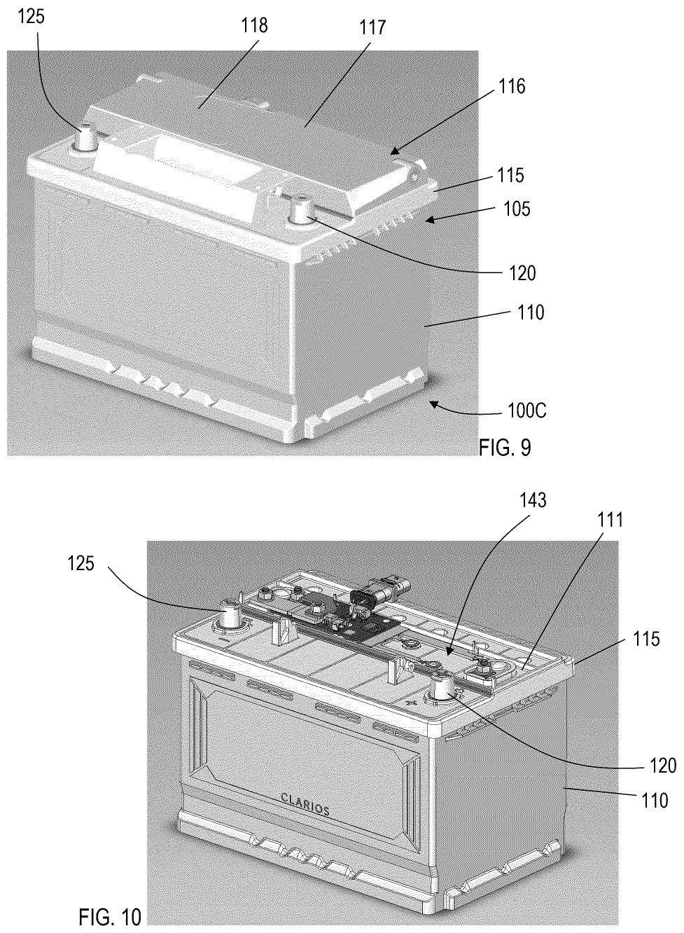

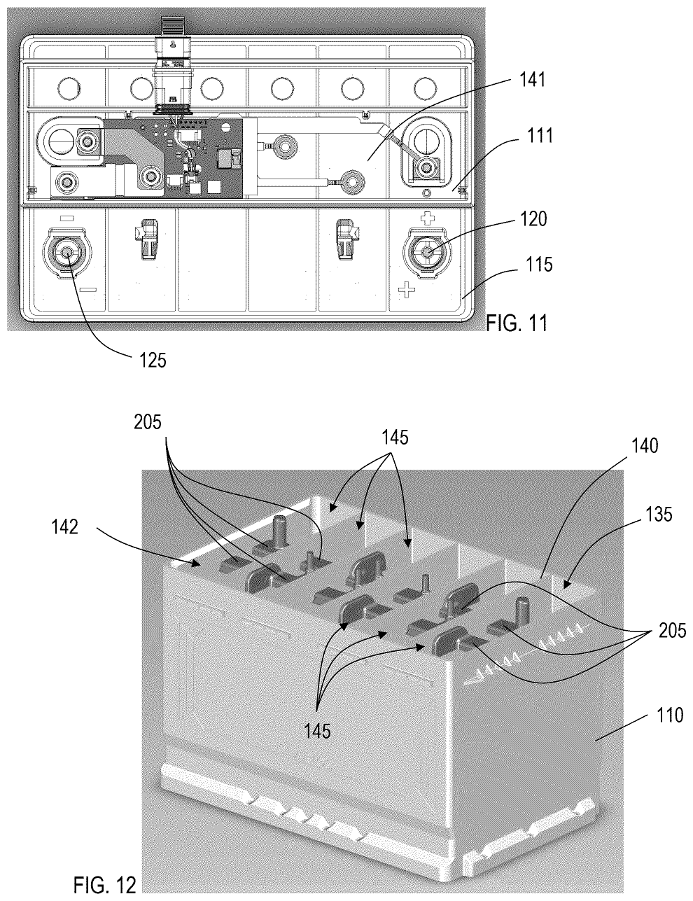

FIGS. 5-8 show a first lead-acid battery system 100B with a housing 105B. The lead-acid battery system 100B has a housing that meets the German Industrial Standard (DIN) battery size of H3. FIGS. 9-12 show a second lead-acid battery system 100C with a housing 105C. The lead-acid battery system 100C has a housing that meets the German Industrial Standard (DIN) battery size of H6. For the remainder of this detailed description, unless indicated with a “B” or “C”, a reference number without a B or C indicates either variation of the battery system 100B or the battery system 100C. A reference number with a “B” indicates the construction having the H3 battery size of FIGS. 5-8, i.e., battery system 100B. A reference number with a “C” indicates the construction having the H6 battery size of FIGS. 9-12, i.e., battery system 100C. While described in connection with the battery system 100B or the battery system 100C, this does not mean the discussed element is limited to only batteries or battery systems of that size. Rather, the element being discussed with the “B” or “C” is best shown in the construction of the battery system 100B or 100C, respectively.

The battery system 100 can be used with vehicles or other non-vehicle applications. As previously communicated with FIGS. 1-3, above, it should be understood by one skilled in the art, that other sizes and styles of AGM lead-acid batteries (e.g., a cylindrical cell-type AGM lead-acid battery, bi-polar AGM battery, AGM batteries with differing cell numbers) and other types of lead-acid batteries (e.g., a non-AGM lead-acid battery, flooded and extended lead-acid batteries, gel-type battery) can be used with the aspects of the invention discussed and/or shown herein. However, for ease of description, this disclosure will generally focus on the style of battery system 100 shown in FIGS. 5-12 and the other figures thereafter.

With reference to FIGS. 5-12, the housing 105 includes a battery cells base 110 and a battery cells cover 115. The cells cover 115 is secured to the cells base 110, for example, by heat sealing the cells cover 115 to the cells base 110. The housing 105 further includes a battery management system (BMS) base 111 and a BMS cover 116. The BMS cover 116 is secured to the BMS base 111, for example, by heat sealing the BMS cover 116 to the BMS base 111. Alternatively, the BMS cover 116 is connected to the BMS base 111 using a number of fasteners (e.g., screws, bolts, chemical fasteners). For the construction shown, the BMS base 111 is integrally formed with the cells cover 115. Also for the construction shown, the BMS cover 116 is a two-component cover having a first cover portion (or first cover) 117, and a second cover portion (or second cover) 118. The battery system 100 further includes terminals 120, 125 protruding through or on the housing (e.g., the cells cover 115 as shown). The terminals 120, 125 are provided on the cells cover 115 for connecting or coupling the battery system 100 to electrical loads (e.g., a vehicle electrical system). A communication connecter 126 (e.g., for coupling to a vehicle connector) protrudes through or on the BMS cover 116.

FIGS. 6, 7 and 10, 11, show the BMS cover 116 removed. Using FIG. 6 as an example, the cells cover 115 includes a platform 131 integrally formed with the cells cover 115. The platform 131 includes a shelf surface 132 and a shelf wall 133. The BMS cover 116 includes an edge and an inner wall. The edge is directly connected to the shelf surface 132, and the inner wall is near the shelf wall 133. More specifically, the BMS cover 116 can use the shelf wall 133 to help align the edge of the BMS cover 116 onto the shelf surface 132. In the shown construction, the edge is continuous on a perimeter of the BMS cover 116 and the edge is in continuous contact with the shelf surface 132 (best shown in FIG. 5). The BMS cover 116 can then be sealed with the shelf surface 132 and or shelf wall 133. Also shown in FIG. 6, the platform 131 can include multiple ramps 134 and an outer wall 136 to help align the BMS cover 116 with the platform 131.

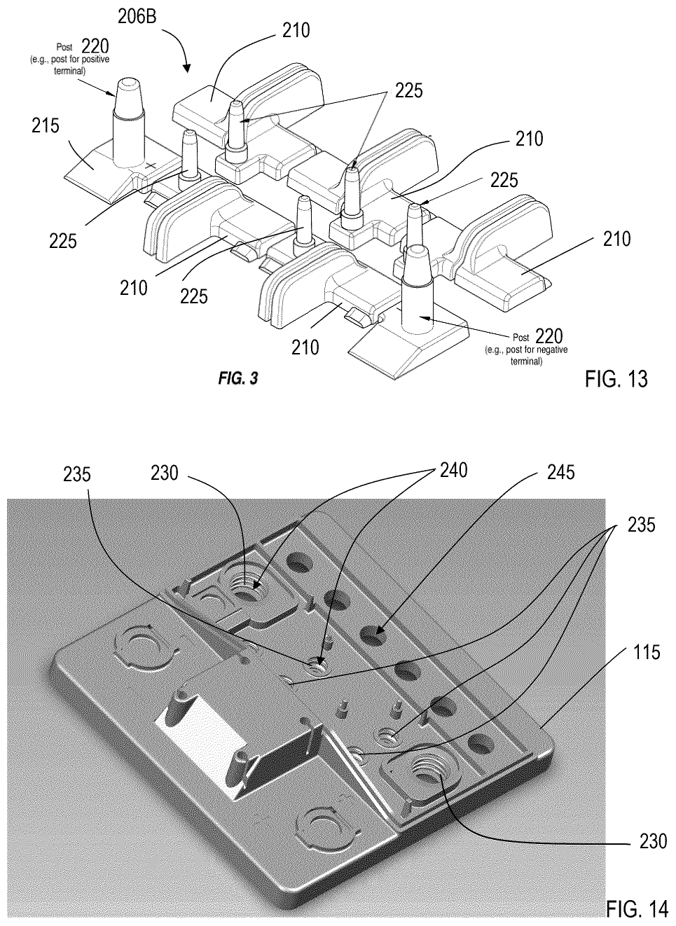

FIGS. 8 and 12, shows the cells cover 115 removed. The cells base 110 supports a plurality of battery cell chambers (one chamber 135 is labelled). The cell chambers can be formed by the cells base 110 and a plurality of cell walls or partitions (one wall 140 is labelled) that define the plurality of cell chambers. The partitions may be formed as being unitary with the cells base 110. While the constructions discussed herein have six cell chambers, a different number of cells chambers may be provided. Further, while the shown chambers are a generally rectangular shape, other shapes may be used for the chambers. The cell chambers (and related battery cells 145) may conventionally be referred to by number (e.g., 1, 2, 3, 4, 5, 6).

The battery cells 145 include a plurality of positive frames or plates, a plurality of separators partially surrounding the positive plates, and a plurality of negative frames or plates. The design and implementation of the battery cells 145 can be similar to what was discussed above with the battery of FIGS. 1-3, which is incorporated here.

The housing 105, including the cells base 110, the cells cover 115, the BMS base 111, and the BMS cover 116, may be made of any polymeric (e.g., polyethylene, polypropylene, a polypropylene containing material, etc.), acryl butyl stearate (ABS), polycarbonate, or composite (e.g., glass-reinforced polymer) material. For example, the housing 105 may be made of polypropylene-containing material (e.g., pure polypropylene, co-polymers comprising polypropylene, polypropylene with additives, etc.). Such polymeric material is relatively resistant to degradation caused by acid (e.g., sulfuric acid) provided within cells of the container. Further, and as will be discussed in more detail, a wall 141, which is part of the housing 105, between the cells compartment 142 and the BMS compartment 143, is also resistant to degradation caused by acid provided within the cells chamber 135. The cells cover 115 and the BMS base 111 in the BMS compartment 143 can be the unitary wall 141 and is shown in the examples herein as the unitary wall 141.

The cells compartment 142 includes cast-on battery straps 205 coupling one cell to the next or one cell to a terminal. The combination of the cast-on battery straps 205 and battery cells 145 create the battery voltage. Example battery straps 205 include the battery straps, as shown herein, and which are also shown and described in PCT Application No. PCT/US2023/60031, which is incorporated herein by reference.

The battery straps 205, according to various constructions, connect a number of battery cells 145, for example six battery cells, in series. The battery cells 145 may be comprised of flat-plates, similar to plates 150, 160 above, stacked together. Each plate can have a respective lug extending out of the top of the grid. The battery straps 205 may be understood to connect the lugs of the grids in the battery cells 145 together. It is envisioned that the battery straps 205, as is known in the art, may be of a different design and/or connected to the lugs by different means.

FIG. 13 shows an example post assembly 206B for the battery system of FIG. 5. The shown battery straps 205 comprise connecting straps 210 and further comprise end straps 215. Five connecting straps 210 are shown in FIG. 13, which couple six battery cells in series. The positive terminal 120 and the negative terminal 125 are electrically coupled to terminal posts 220 and end straps 215. The positive and negative terminals 120, 125 are shown on opposite sides of the battery system 100 in the illustrated examples. A connecting strap 210 connects the lugs of a first polarity of battery plates of a battery cell to the lugs of the battery plates of an opposite polarity of a second battery cell. A terminal post 220 connected to an end strap 215 having a polarity (e.g., a positive terminal post corresponding to the positive terminal 120) connects the lugs of plates of the same polarity (e.g., positive) of one end battery cell. Similarly, another terminal post 220 connected to an end strap 215 having an opposite polarity (e.g., a negative terminal post corresponding to the negative terminal 125) connects the lugs of plates of the same polarity (e.g., negative) of the other end battery cell. This provides all six cells being connected in electrical series to result in the battery voltage for the battery system 100. Other series and parallel battery cell arrangements are possible for the battery system as is known in the art to provide different and/or multiple voltages.

In various constructions, the battery straps 205 comprise a lead or lead alloy. The lead alloy may be a substantially pure lead and may, in various constructions, include lead, tin, antimony, calcium, and combinations thereof. The alloy, as a non-limiting example, may be a lead-tin alloy with a tin composition range of 1-4%, 1-2.25%, 1-1.5%, and the like. The lead may be virgin lead or high purity lead or highly purified secondary lead, in numerous examples of constructions. In some implementations, one or more of the battery straps 205 may be made of any material and/or coated (i.e., at least a portion) using one or more materials such as coated using an insulator material.

Each battery strap 205 includes strap posts (e.g., terminal posts 220, mini posts 225) that are coupled with the battery strap 205. For example, the strap posts can be integrated (including directly cast) on the battery strap 205, welded onto the battery strap 205, or connected by other means. The strap posts 220/225 protrude from the cells compartment 142 through the cells cover/BMS base 115/111 (i.e., the compartment wall 141) into the BMS compartment 143 (see FIGS. 6 and 10). For example, each strap post 220/225 may be in communication with a measurement device to measure a voltage of each battery cell and/or set of battery cells.

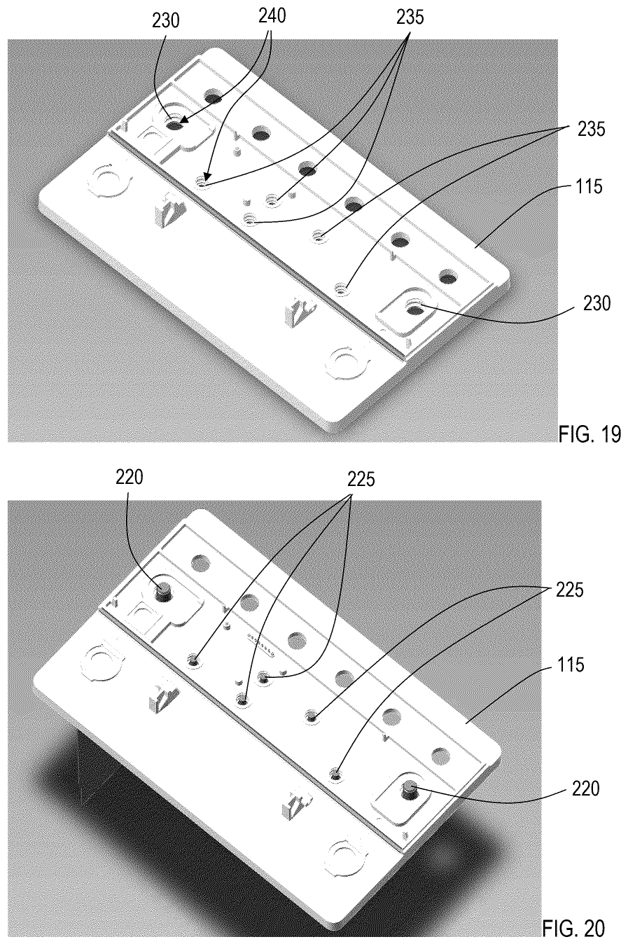

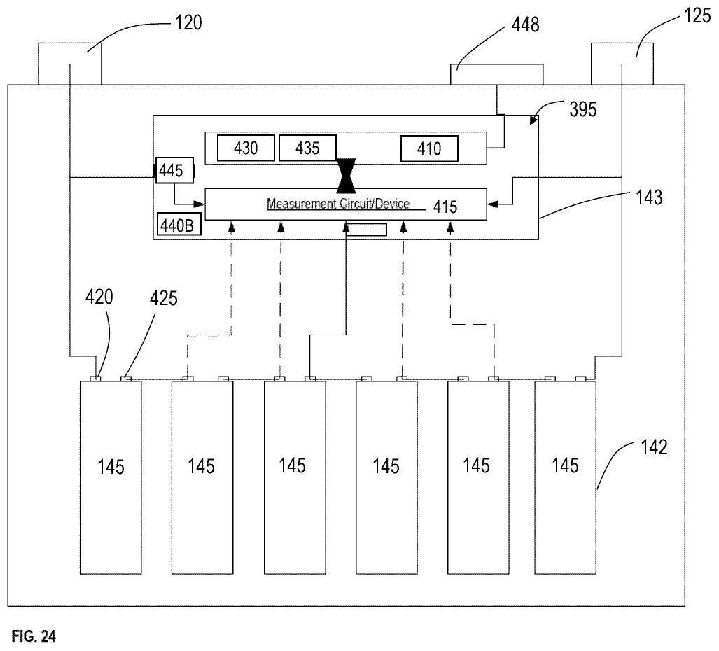

The strap posts 220/225 protrude through bushings (e.g., standard bushings 230, mini bushings 235, shown in FIGS. 14 and 19). The cells cover 115 may include one or more bushings such as mini bushings 235 and standard bushings 230. A standard bushing 230 may refer to a bushing arranged to conform to the specifications of one or more parts of a standard type of battery. For example, a standard bushing 230 may be arranged to conform to the shape/size of a standard post (e.g., a post meeting the specifications of a standard battery such as a terminal post). A mini-bushing 235 may refer to a bushing arranged to conform to the specifications of one or more mini-posts. A standard post (e.g., terminal post 220) is designed with a diameter to allow the post to carry the full-rated current of the battery system 100. A mini post 225 is designed with a diameter to allow the post to make voltage measurements and is designed to allow a minimal current (i.e., much less than full-rated current) to the BMS 395 (shown and described with FIG. 24). However, because the mini post 225 consists essentially of a lead or lead alloy, the mini post 225 requires a minimum diameter to work the post. An example diameter for the terminal post at its smallest diameter is 7 mm with a range of 5 mm to 10 mm or more. An example diameter for the mini post at its smallest diameter is 3 mm with a range of 1.5 mm to 5 mm.

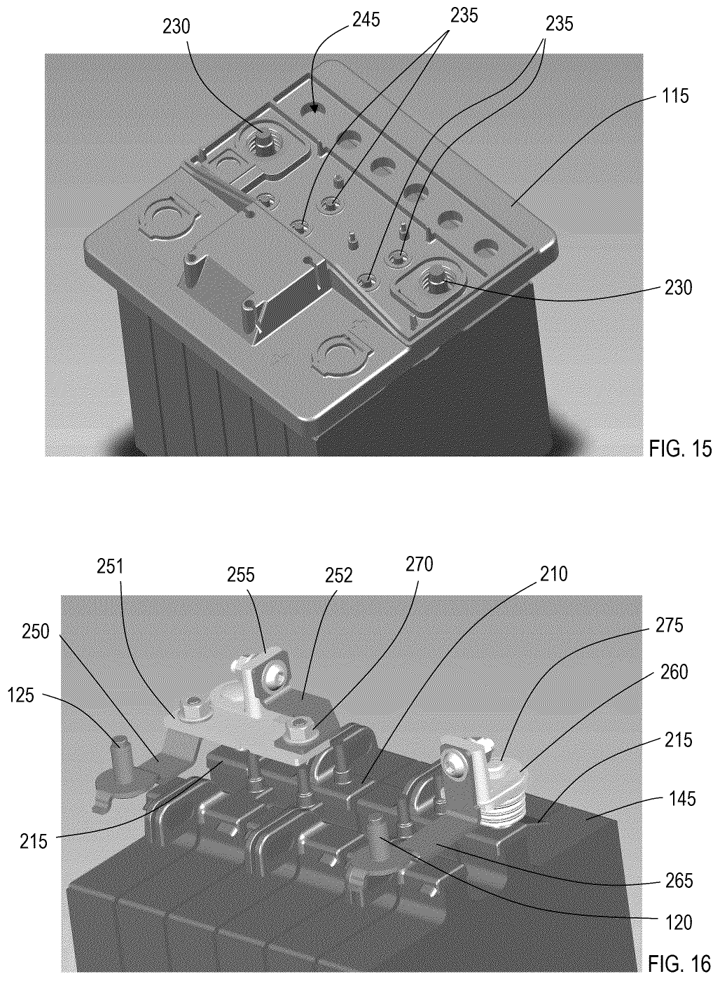

A first terminal post 220 is electrically connected to the positive electrodes of a battery cell 145 and electrically connected to the positive terminal 120 of the battery system 100. A second terminal post 220 is electrically connected to the negative electrodes of a battery cell 145 and electrically connected to the negative terminal 125 of the battery system 100. Each one of the five mini posts 225 are electrically connected to a positive portion of one battery cell 145 and a negative portion of an adjacent battery cell 145. Of course, one skilled in the art can arrange the straps, posts, and sense arrangements differently from what is shown. The strap posts 220/225 are arranged to protrude through a respective bushing 230/235 (shown in FIGS. 15 and 20) of the cells cover 115 and couple to a lead assembly (discussed below) for the BMS. For example, each strap post 220/225 may be in communication with the BMS to measure one or more parameters disclosed earlier.

FIG. 14 shows an example cells cover 115B for the battery system of FIG. 5. The cells cover 115 includes standard bushings 230 and mini bushings 235. The cells cover 115 is arranged to include one or more cover openings (two openings are labelled 240) be arranged to receive terminal posts 220 and mini posts 225. This is shown in FIG. 15. The bushings 230/235 provide sealing features, where coupling the bushings 230/235 to the cells cover 115 and to the strap posts 220/225 seals the BMS compartment 143 from the cells compartment 142. Further, the cells cover 115 may comprise one or more cover openings which may be arranged as vent openings (one vent opening is labelled 245) The vent openings 245 allow fluid (e.g., gas) communication with the internal space of the cells compartment 142.

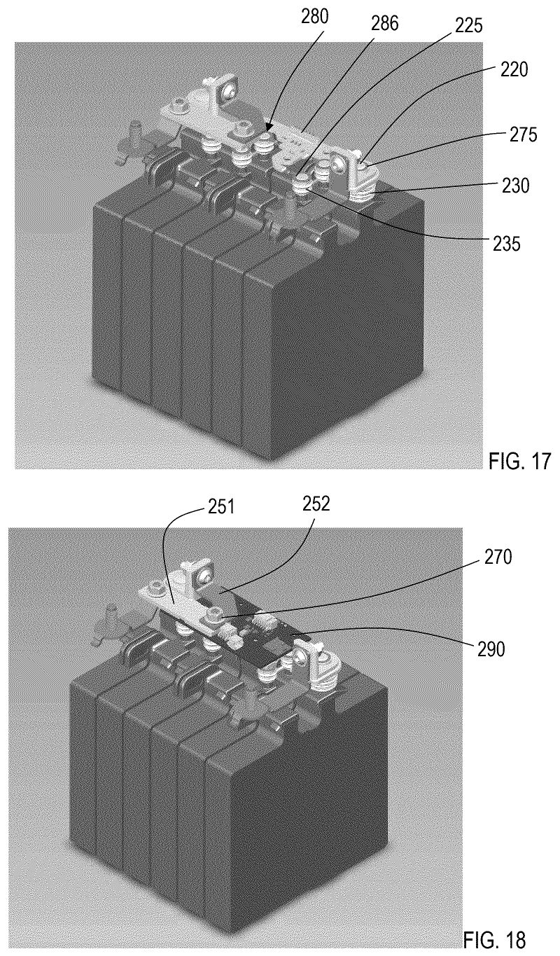

A main electrical path from the negative battery terminal 125 to the positive battery terminal 120 is shown in FIG. 16. The electrical path includes negative terminal 125, coupler bars 250, 251, 252, connector 255, end strap 215, schematically represented battery cells 145 and connecting straps 210 (one of each is labelled in FIG. 16), end strap 215, connector 260, coupler bar 265, and positive terminal 120. A current sense path is provided by connecting a current sensor of the BMS 395 (best shown in FIG. 24) to the coupler bar 251 (best shown in FIG. 18). The current sense path can also provide a voltage sense point 270 (best shown in FIG. 18) corresponding to the negative terminal 125 and the first cell voltage. A second voltage sense point 275 (best shown in FIG. 17) corresponds to the positive terminal 120 and the last cell voltage. The second voltage sense point 275 can be coupled to the terminal post 220 (FIG. 17) or a connection point on a bus (FIG. 22). Other series and parallel battery cell arrangements are possible for the battery system 100 as is known in the art to provide different and/or multiple voltages.

FIG. 17 shows strap posts (e.g., terminal posts 220, mini posts 225) protruding through bushings (e.g., standard bushings 230, mini bushings 235). A lead assembly 280 is fixed (e.g., welded) to the strap posts 220/225 with ring connectors (one ring connector 285 is labelled in FIG. 17). The lead assembly 280 further includes a BMS connector 286. Further discussion regarding the mini bushings 235 and the lead assembly 280 will be provided below.

FIG. 18 shows a circuit board assembly, which is a printed circuit board (PCB) assembly 290, coupled to the BMS connector 286. The PCB assembly 290 provides the BMS 395, discussed below. Also connected to the PCB assembly 290 are the coupler bars 251, 252 for measuring current and acquiring a voltage. The PCB assembly 290 can also include additional connectors for temperature measurements (discussed below) or other parameters.

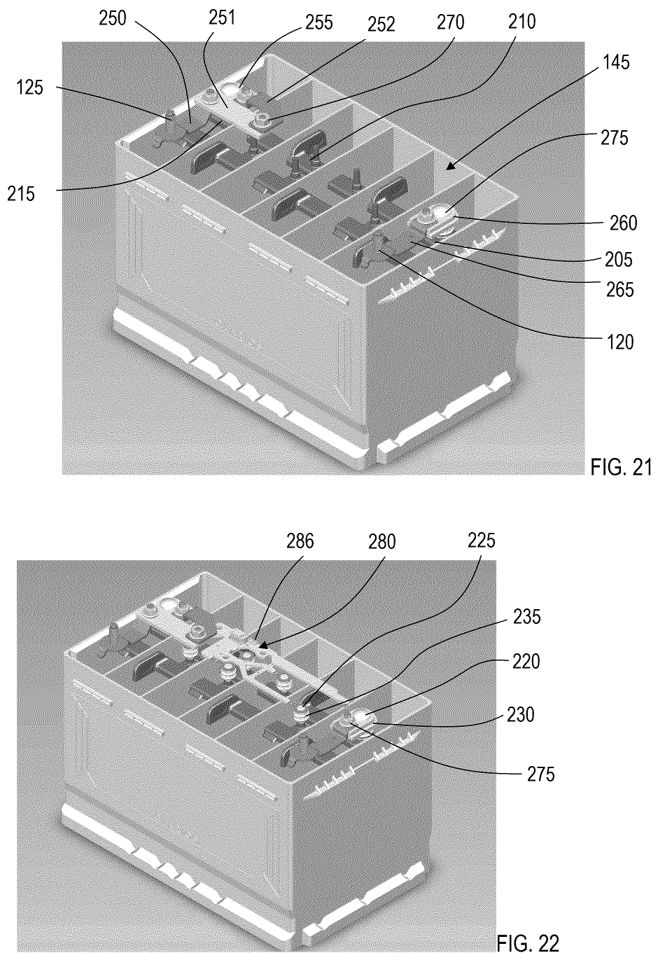

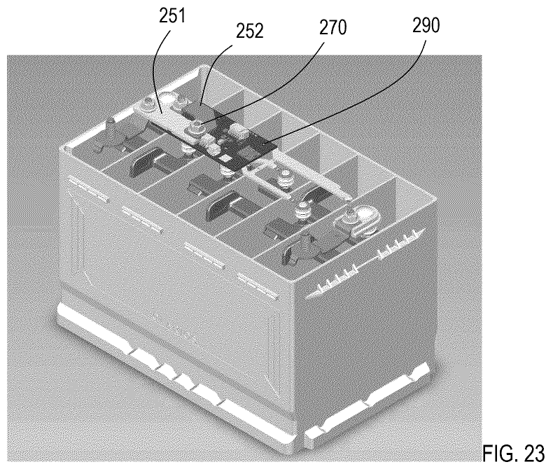

FIGS. 19-23 generally correspond to FIGS. 14-18 but are for the H6 battery of FIG. 9 instead of the H3 battery of FIG. 5.

The battery system 100 is a “smart” battery system. FIG. 24 is a block diagram for an implementation of the smart lead-acid battery systems 100 of FIGS. 5 and 9. The lead-acid battery system 100 of FIG. 24 has an integrated battery monitoring system (BMS) 395 disposed within the BMS compartment 143, thereby resulting in a battery system. In one or more alternative implementations, the BMS 395 may be partially located remote from the battery system 100.

As shown in FIG. 24, the battery system 100 includes an array of battery cells (which are schematically represented as 145) electrically connected to the BMS 395. The BMS 395 includes a communication module 410 configured to receive and/or transmit signals from external devices (e.g., a vehicle). For example, certain constructions of the BMS 395 include a communication module 410 that includes a transmitter capable of communicating through radio frequency signals, such as via a Bluetooth connection, a wireless local area network connection, a cell phone data connection (e.g., code division multiple access), or other suitable connection. The communication module 410 can alternatively or additionally use a wired-communication scheme. Example wired communication standards include controller area network (CAN), local interconnect network (LIN), on-board diagnostic (e.g., OBD-II), recommended standard (e.g., RS-485), etc.

In the illustration, the BMS 395 includes a battery measurement device/circuit 415. The battery measurement device/circuit 415 includes one or more sensors configured to monitor the battery cells 145 and is configured to output a signal indicative of parameters (e.g., cell voltages) to the BMS 395. As illustrated, leads are coupled to various terminals (or lugs). Depending on the attached leads, the measurement device 415 can acquire individual cell voltages, group cell voltages, and/or battery voltages for the battery system 100. For the shown example, the measurement circuit 415 is located in the BMS compartment 143.

For the battery system 100, the measurement circuit 415 can include voltage sensors (e.g., voltmeters) electrically coupled to the various leads provided to the measurement circuit 415. Because the first lead is electrically connected to the positive post 420 and the second lead is electrically connected to the negative post 425, the voltage sensor senses the voltage across the battery cell 145. The voltage sensor is coupled to a processor 430 and a memory 435. The processor 430 receives a signal from the voltage sensor indicative of the cell voltage, and to determine the cell voltage based on the signal. For example, in certain implementations, the voltage sensor outputs an analog signal proportional to the sensed voltage. In such implementations, the processor 430 may be configured to convert the analog signal into a digital signal, and to determine the voltage based on the digital signal. The memory 435 may be configured to store battery cell identification information, operational parameter history information, battery cell type information, and/or usage information. For example, a unique identification number may be associated with each battery cell 145 and stored within the memory 435.

It should be appreciated that the battery system 100 includes additional sensors configured to monitor other operational parameters of the battery cells 145 and or the battery system 100. The measurement circuit 415 can include a temperature sensor 440. The temperature sensor 440 outputs a signal indicative of the battery cell temperature. For example, the temperature sensor 440 may output an analog signal proportional to a measured temperature. It should also be appreciated that alternative constructions may include additional sensors configured to monitor other operational parameters of the battery cell 145. For example, the measurement circuit 415 may include a sensor configured to measure the state of charge within the battery cell 145, a current sensor 445 configured to determine a current being provided by the battery cell 145, a pressure sensor configured to detect an excessive pressure within the battery cell 145, an acid density measurement to measure acid density in a battery cell 145, and/or other sensors configured to monitor an electrical, physical, or chemical parameter of the battery cell 145.

The processor 430 can include a component or group of components that are configured to execute, implement, and/or perform any of the processes or functions described herein for the BMS 395 or a form of instructions to carry out such processes or cause such processes to be performed. Examples of suitable processors include a microprocessor, a microcontroller, and other circuitry that can execute software. Further examples of suitable processors include, but are not limited to, a core processor, a central processing unit (CPU), an array processor, a vector processor, a digital signal processor (DSP), a field-programmable gate array (FPGA), a programmable logic array (PLA), an application specific integrated circuit (ASIC), math co-processors, and programmable logic circuitry. The processor 430 can include a hardware circuit (e.g., an integrated circuit) configured to carry out instructions. In arrangements in which there are a plurality of processors, such processors can work independently from each other, or one or more processors can work in combination with each other.

The memory 435 includes memory for storing one or more types of instructions and/or data. The memory 435 can include volatile and/or non-volatile memory. Examples of suitable memory include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, disks, drives, or any other suitable storage medium, or any combination thereof. The memory 435 can be a component of the processor 430, can be operatively connected to the processor 430 for use thereby, or a combination of both.

In one or more arrangements, the memory 435 can include various instructions stored thereon. For example, the memory 435 can store one or more instruction (e.g., software or firmware) modules. The instruction modules can be or include computer-readable instructions that, when executed by the processor 430, cause the processor 430 to perform the various functions disclosed for the battery system 100. While functions may be described herein for purposes of brevity, it is noted that the functions for the battery system 100 are performed by the processor 430 using the instructions stored on or included in the various modules. Some modules may be stored remotely and accessible by the processor 430 using, for instance, various communication devices and protocols.

The memory 435 may also be configured to store battery identification information, battery operational parameter history information, battery type information, and/or battery usage information. The memory 435 may be further configured to store, for each battery cell 145, battery cell identification information, battery cell operational parameter history information, battery cell type information, and/or battery cell usage information. For example, a unique identification number may be associated with each battery cell 145 and stored within the memory 435. In such a configuration, the battery monitoring unit may identify a particular battery cell 145 based on the unique identification number, thereby providing more context to the measured parameters. The memory 435 may also be configured to store historical values of measured operational parameters of the battery system 100 and the battery cells 145. For example, the memory 435 may store the maximum and/or minimum voltage measured by a voltage sensor. Such information may be useful for diagnosing faults within a battery cell, as will be discussed in some of the further constructions below. Furthermore, the memory 435 may be configured to store usage information, such as average load, maximum load, duration of operation, or other parameters that may be useful for monitoring the operational status of the battery system 100 and/or battery cells 145. Similar information may be stored in the BMS 395 for combinations of battery cells 145 (e.g., cells 1-3 and cells 4-6).

The battery system 100 also includes a communication (or connector) port 448 for connecting a communication cable to the housing 105. The communication port 448 can promote communication between the battery system 100 and an external apparatus, such as a vehicle control module if the battery system 100 is used in a vehicle.

Before moving to other components, it should be understood by somebody skilled in the art that the battery monitoring unit may include additional conventional elements typically found in a battery system or a monitoring unit. Further discussion regarding these components is not provided herein since the components are conventional and their operation are conventional.

During one operation of the battery system 100, each measurement circuit 415 monitors a cell voltage of each respective battery cell 145 the measurement circuit 415 is associated with. The measurement circuit 415 can sense other parameters associated with the battery system 100, such as a total battery voltage, various combinations of battery cell voltages, a total battery current, a total battery charge, etc. Analog value or processed value can be provided to the BMS 395 by the measurement circuit 415. Based on the acquired parameters and related values, the BMS 395 can determine a state of health of the lead-acid battery system 100, particularly the battery system 100 and the battery cells 145. Further based on the acquired parameters and related values, the BMS 395 can determine a state of function of the lead-acid battery system (e.g., readiness in terms of usable energy by observing state-of-charge in relation to the available capacity), particularly the battery and battery cells. By monitoring cell voltage, the BMS 395 can identify a potentially faulty cell, thereby identifying a possible issue for the lead-acid battery system 100 sooner than an external (e.g., vehicle) control unit can identify a possible issue through the total battery voltage. The lead-acid battery system 100 herein can also provide better prediction capabilities using the additional voltage information related to the individual battery cells 145. By extension, this applies to the other possible cell parameters (discussed above) sensed by the measurement devices 415 and the BMS 395.

The information related to the lead-acid battery system 100 and the state of the lead-acid battery can also be communicated through a wire connection and/or through wireless communication. For example, information may be communicated to the vehicle control module, which can provide information to the driver via the indicator panel. Alternatively, an analysis tool can be coupled (either wireless or direct connection) to the lead-acid battery system 100 for communicating with the BMS 395, and more specifically obtain information from the memory 435.

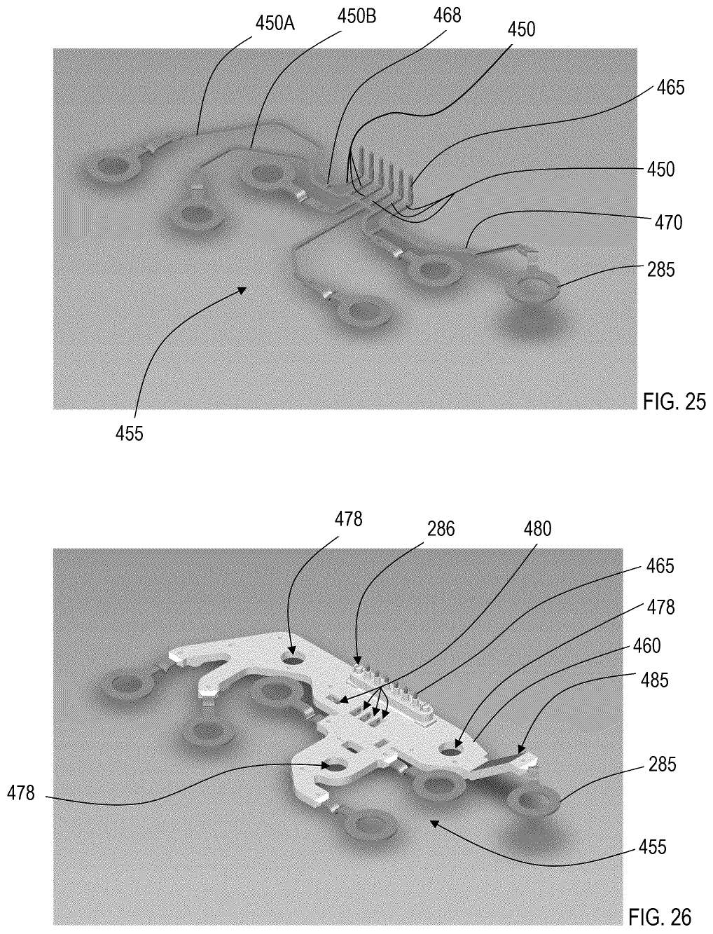

FIG. 25 shows an example of a plurality of leads 450 (e.g., six leads) as a lead skeleton 455. Each lead 450 includes one or more of each of the following (only one of which is labelled in FIG. 25): a post connector 285, a BMS connector 465, and a conductive path 470 connecting the post connector 285 to the BMS connector 465. In the illustrated example, the lead skeleton 455 may be stamped in the shape of a frame and configured to electrically couple various posts to voltage sensors. The lead skeleton 455 may be made of lead or a lead alloy. Similar to the discussion above, it should be contemplated within the present disclosure that a “smart” lead-acid battery system constructed with the lead skeleton 455 can be communicatively coupled to the processor 430 and memory 435.

Referring now to FIG. 26, the example lead skeleton 455 is coated with a protective and/or electrically insulating over molding, referred to herein as a lead body 460. The over molding provides structural support to the lead skeleton 455 and improve ease of manufacturing. The lead body 460 can be an overmolding polymer (e.g., to make lead assembly 280) over the leads 450 to thereby provide structure for the leads 450. Lead assembly 280 can be rigid or flexible or a combination thereof depending on the intended design.

The lead skeleton, as shown in FIG. 25, can further include support connectors (one connector 468 is labelled in FIG. 25). Each support connector 468 couples one lead (e.g., lead 450A) of the plurality of leads 450 with an adjacent lead (e.g., lead 450B) of the plurality of leads 450. The support connectors 468 provide structural support to the lead skeleton 455 and improve ease of manufacturing prior to the addition of the lead body 460.

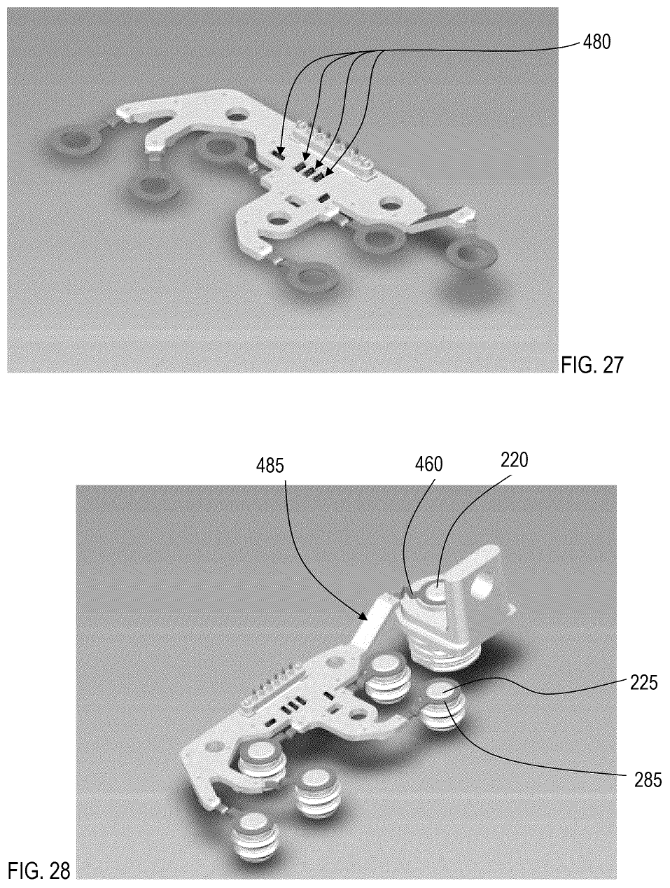

The post connectors 285 are shown as ring connectors. The ring connectors 285 are arranged to physically and/or electrically connect a lead 450 to a respective post, for example the mini posts 225 (see FIG. 28). Other shapes, and additional conductors (e.g., spikes) are possible for the post connectors 285.

The BMS connectors 465 of the lead 450 are arranged to extend from the conductive paths 470 to a corresponding connector of the PCB assembly 290. The BMS connectors 465 can bend to a predetermined angle and/or physically and/or electrically connect to the BMS 395 and/or any of its components.

The leads 450 may be made of any material including conductive materials, e.g., to conduct and/or propagate signals. In a nonlimiting example, the lead skeleton 455 is a stamped frame and be made of at least one of copper, brass, steel, aluminum, titanium, platinum, etc. Further, leads 450 may include a coating and/or a finish such as a finish using copper, nickel, tin, palladium, silver, gold, zinc, etc. The leads 450 may be used by the BMS 395 to measure/determine one or more parameters associated with a strap post 220/225 and/or corresponding battery cells 145.

The lead skeleton 455 may be comprised in a lead assembly 280 further comprising the lead body 460. The lead body 460 can be an over molded assembly as shown in FIG. 26. Further, the lead body 460 includes one or more apertures 478 arranged for coupling lead assembly 280 to the cells cover 115 and one or more apertures 480 for exposing at least a portion of the support connectors 468. The apertures 480 allow the breaking of the structure support connectors 468 after the lead body 460 forms. The breaking of the structures 468 electrically isolates each lead 450 from the adjacent lead 450, for example 450A from 450B.

A portion of each lead 450 may be hinged and/or adapted to be flexible and/or adjustable. For example, lead 450 can connect to a terminal post 220 that may be in a different plane than a plane corresponding to main portion of the lead assembly 280. As a more detailed example, a terminal post 220 (e.g., the positive terminal post shown in FIG. 28) may be located on a different plane than a plane where other mini posts 225 are located. In other words, it is contemplated that a terminal post 220 need not be co-planar with respect to the top surface of the mini posts 225. The lead assembly 280 includes arm 485 which may be arranged to adjust the location of a portion of lead assembly 280. The arm 485 adjusts the plane of the corresponding conductive path 470 to a predetermined terminal post 220, such varying the plane of a ring corresponding with the terminal post 220 that is not coplanar with others of the rings corresponding with the mini posts 225 (see FIG. 28). The portion of the arm 485 including the plane changing bends for the differing posts is internal to the terminal body to allow more support structure for the arm 485.

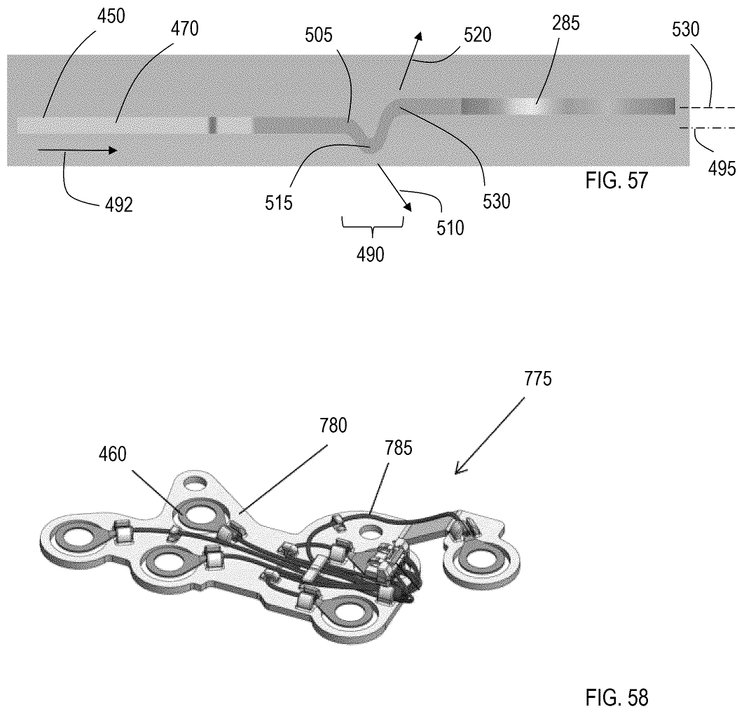

Another example of a flexible or hinged bend is shown in FIGS. 25 and 57. FIG. 57 shows a portion of the conducting path 470 and a ring connector 285. The bend is part of an intermediate path 490 in the conductive path 470. The bends of the intermediate path 470 are nearer to the ring connector 285 than the BMS connector 286 and are external to the lead body. This allows flexing or movement of the ring connector 285 as part of the assembly process to connect the ring connector 285 to the mini post 225. The bends of the intermediate path 490 can also allow the conductive path 470 to change from a first plane 495 to a second plane 500. This allows the lead assembly 280 to sit lower within the BMS compartment 143 than as compared to the ring connector 285 sitting in the first plane. Further, the top surface of the ring connector 285 can be in the same plane as the top surface of the lead body. In one implementation, the bends of the intermediate path 490 is similar to the bends discussed in the previous paragraph for the arm 485. In other implementations, the bends of the intermediate path 490 can be more complex. For example, the hinged bends in FIG. 25 include a “U-shaped” bend for each lead. An enlarged view of the U-shaped bend is shown in FIG. 57.

With reference to FIG. 57, a single lead 450 is shown. The lead 450 has a conductive path 470 from the BMS connector 286 to the ring connector 285. The ring connector 285 couples to a mini post 225. The conductive path 470 extends in a first direction 492 in a first plane 495. The conductive path 470 includes an intermediate path 490. The conductive path 470 from the BMS connector to the ring connector 285 includes a path in a first direction 492 in a first plane 495. At the U-Shaped Bend, a first bend 505 has an obtuse angle changing the direction of the conductive path to a second direction 510. Next, a second bend 515 has an acute angle changing the direction of the conductive path 470 from the second direction 510 to a third direction 520. Last, a third bend 525 has an obtuse angle changing the direction of the conductive path 470 from the third direction 520 to the first direction 492. Further, the conductive path 470 after the third bend 525 is in a second plane 530, which is different than the first plane 495. Additional bends from the shown bends 505, 515, and 525 are envisioned. Accordingly, the majority of the lead skeleton 455 sits in a lower plane; i.e., the first plane 495, than the ring connectors 285. Moreover, the inclusion of the bends 505, 515, and 525 allow the ring connectors 285 to be more flexible during the assembly process.

It should also be noted from FIGS. 25, that the cross-sectional area of the leads 450 can be smaller within the lead body 460 than outside of the lead body 460. The larger cross-section area allows for additional rigidity. Further, the larger cross-sectional area is rectangular allowing for more flexing in one direction over the other. Lastly, the lead 450 associated with arm 470 has a larger cross-sectional area within the body 460 than the other leads to allow for a greater current to travel the conductive path since it connected to the terminal lead 220.

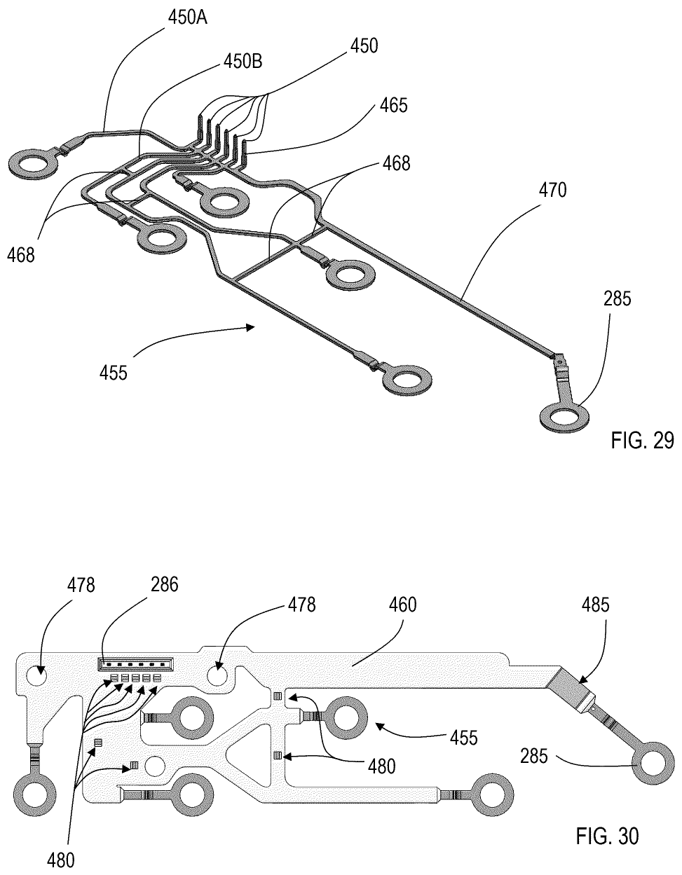

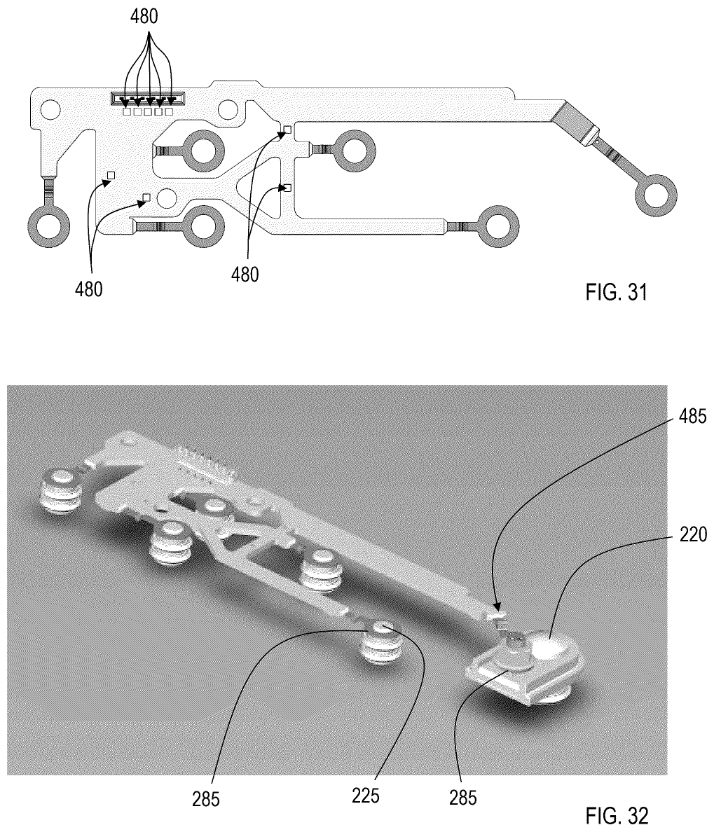

FIGS. 29-32 generally correspond to FIGS. 25-28, but are for the H6 battery of FIG. 9 instead of the H3 battery of FIG. 5.

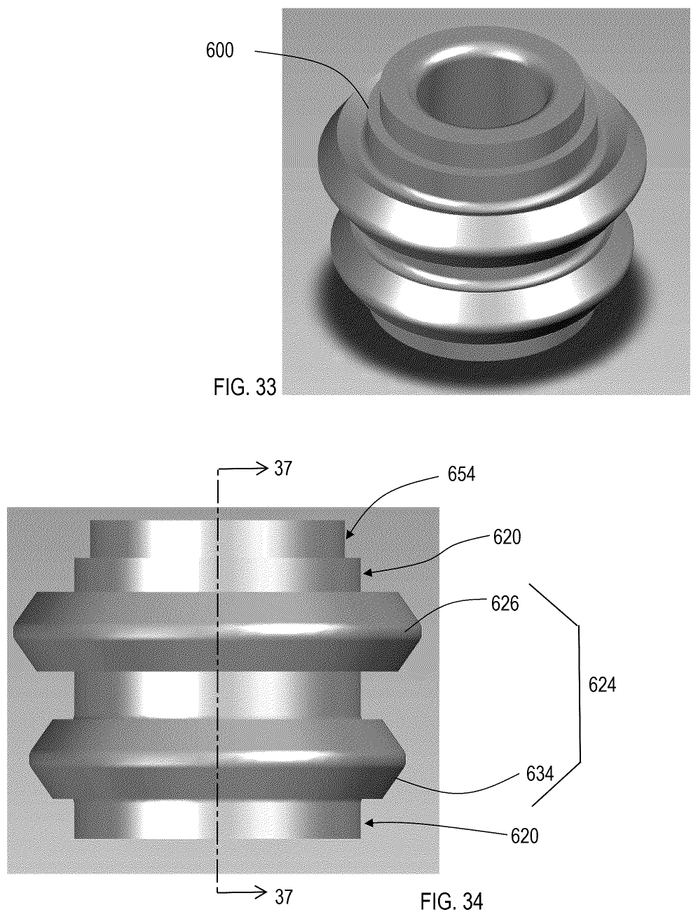

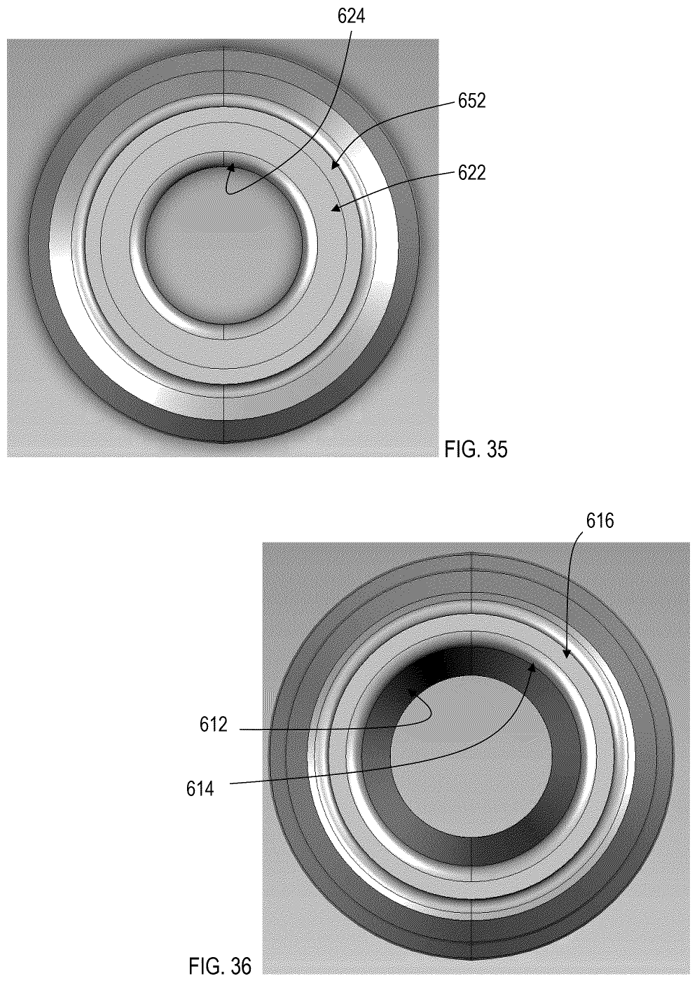

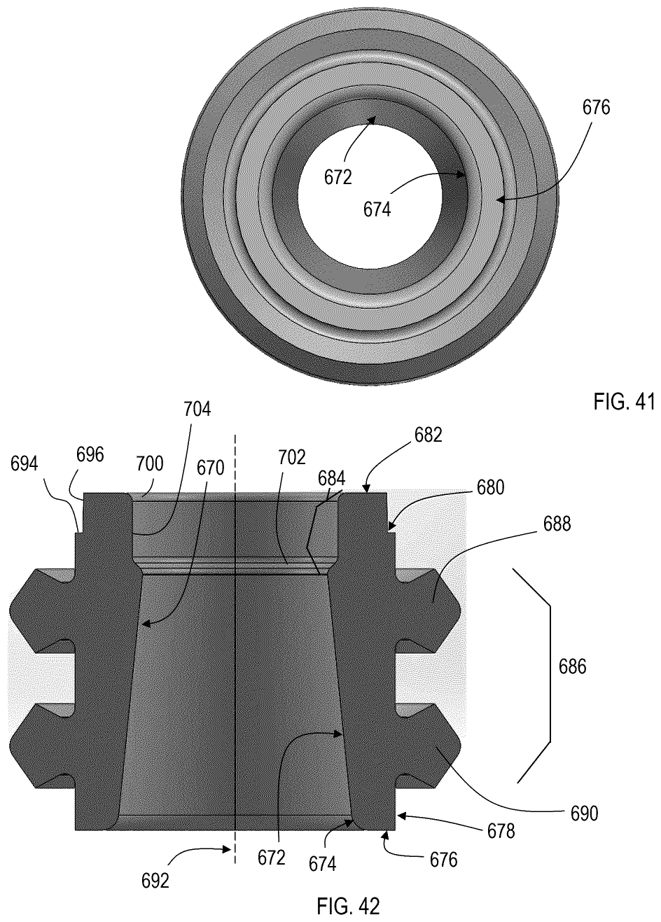

FIGS. 33-37 show an example mini bushing 600 for the lead acid battery 100B. FIGS. 38-42 show an example mini bushing 605 for the lead acid battery 100C. It is envisioned that other bushing designs can be used in alternative to the mini bushings 600, 605. The mini bushings 600, 605 receive mini posts 225. The mini bushings 600, 605 can be made of one or more materials (e.g., lead, bronze, gold, etc.). The mini bushings 600, 605 may be arranged to provide friction reduction between parts (e.g., mini posts 225 and cover openings 240) and/or isolation between parts (e.g., mini posts 225 and cover openings 240).

As discussed above, a standard bushing may refer to a bushing arranged to conform to the specifications of one or more parts of a standard type of battery. For example, a standard bushing may be arranged to conform to the shape/size of a standard post. A standard post is a post meeting the specifications of a standard battery. For example, a standard post is a post designed with a diameter to allow the post to carry the full-rated current of the battery system 100. A mini-bushing refers to a bushing arranged to conform to the specifications of one or more mini-posts. A mini post is designed with a diameter to allow the post to make voltage measurements and is designed to allow a minimal current (i.e., much less than full-rated current) to the BMS 385. However, because the mini post consists essentially of a lead or lead allo7, the mini post 225 does require a minimum diameter to work the post. Moreover, the height of a mini post can similarly be less than the height of a standard post. The result of which is the dimensions of the mini bushing, which is sized to receive, hold, and weld with a mini post, is less than a standard bushing, which is sized to receive, hold, and weld with a standard post.

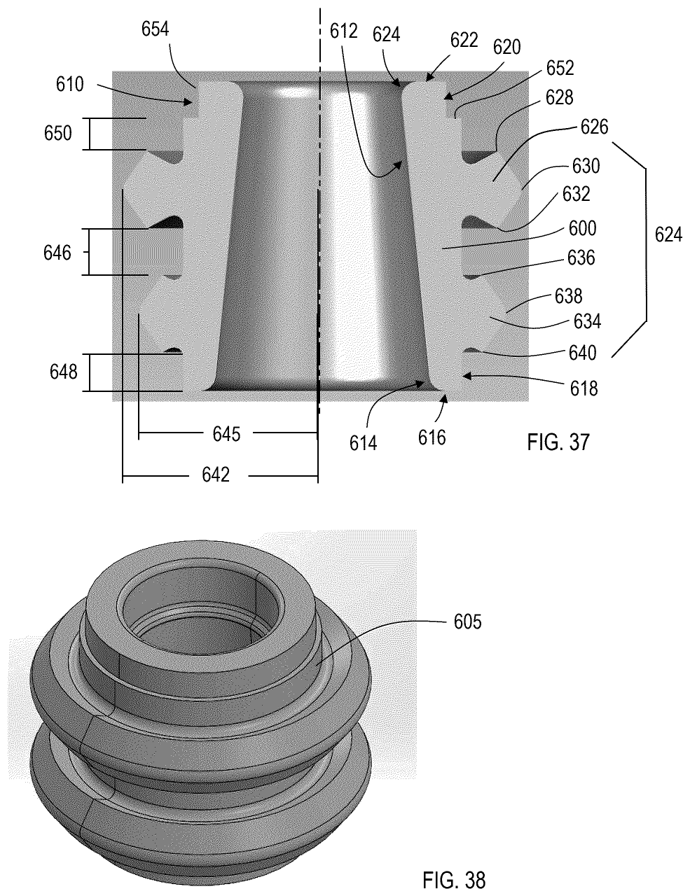

FIG. 37 is a sectional view of the mini bushing 600 along lines 37-37′ in FIG. 34. The bushing 600 has a perimeter 610 around the cross-sectional area shown in FIG. 37. For FIG. 37, the perimeter 610 includes an interior surface 612 coupled (e.g., directly connected or interconnected) to a first fillet surface 614, which is connected to a bottom surface 616, which is connected to an exterior surface 618, which is connected to a stepped surface 620, which is connected to a top surface 622, which is connected to a second fillet surface 623, which is connected to the interior surface 612.

The exterior surface 612 includes a labyrinth section 624 or surface. The labyrinth section 624 includes, along the perimeter, a first arrow-like section or profile 626 with an upper side point 628, a center point 630, and a lower side point 632 and a second arrow-like section or profile 634 with an upper side point 636, a center point 638, and a lower side point 640. For FIG. 37, a first radius 642 from the center axis 644 to one of the points (e.g., 630) is greater than a second radius 645 from the center axis 644 to one of the points (e.g., 638). The labyrinth section 624 includes a distance 646 between the points 632, 636. The distance 646 is large enough to allow housing material to readily flow between the two points 632, 636. For the shown constructions, the arrow-like profiles 626, 634 are offset from the bottom surface and the top surface of the wall 141 by a first distance 648 and a second distance 650, respectively. FIG. 37 shows the first distance 648 and the second distance 650 as being the same distance. The various lengths are large enough to not stress the material between and around the arrow-like profiles 626, 634 during use of the battery. The arrow-like profiles 626, 634 create a larger surface area compared to no arrows to allow the mini bushing 600 to have more contact area with the wall 141 material, create hooks to help better prevent the mini bushing 600 to pull away from the wall 141, and create a better seal for retaining acid within the battery cells compartment.

For the shown surfaces, the internal surface 612 conically enlarges away from the center axis 644 moving away from the top surface 622 towards the bottom surface 616. The first fillet surface 614 has a fillet shape moving from the internal surface 612 to the bottom surface 616. The second fillet 623 surface has a fillet shape moving from the inside surface 612 to the top surface 622. The exterior surface 618 is cylindrical from the bottom surface 616 to the stepped surface 620, but for the labyrinth section 624.

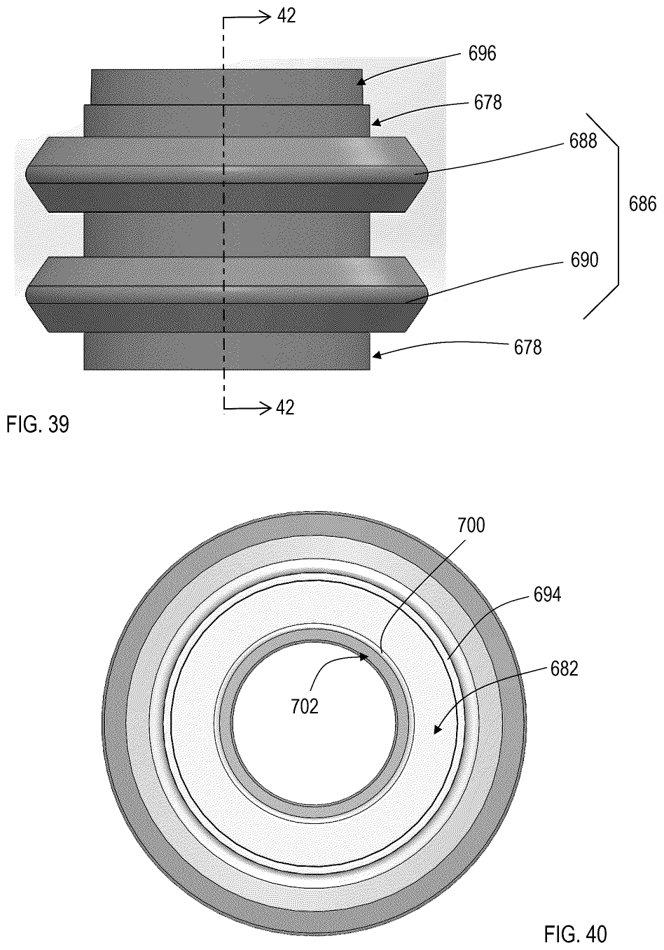

The stepped surface 620 includes a step wall 652 and a step wall 654. The step wall 652 is shaped like a flat ring when viewed from the top (see FIG. 40). The step wall 654 is shaped like a cylinder when viewed from the side (see FIG. 39). It is envisioned that the bushing can include additional surfaces, may not include all of the shown surfaces, and/or may not be circular in shape (as viewed from the top or bottom or along a radial cross-section).

FIG. 42 is a sectional view of the mini bushing 605 along lines 42-42′ in FIG. 34. The bushing 605 has a perimeter 670 around the cross-sectional area shown in FIG. 42. For FIG. 42, the perimeter 670 includes an interior surface 672 coupled to a fillet surface 674, which is connected to a bottom surface 676, which is connected to an exterior surface 678, which is connected to a stepped surface 680, which is connected to a top surface 682, which is connected to a repository (or counterbore) surface 684, which is connected to the interior surface 672.

The exterior surface 678 includes a labyrinth section 686 or surface. The labyrinth section 686 includes, along the perimeter, a first arrow-like section or profile 688 with an upper side point, a center point, and a lower side point and a second arrow-like section or profile 690 with an upper side point, a center point, and a lower side point. For FIG. 42, the labyrinth section 686 includes arrow-like profiles 688, 690 with identical radii. The design considerations for the first arrow-like profile 688 and the second arrow-like profile 690 are similar to the arrow-like profiles 626, 634 in FIG. 37. The arrow-like profiles 688, 690 create a larger surface area compared to no arrows to allow the mini bushing 605 to have more contact area with the wall 141 material, create hooks to help better prevent the mini bushing 605 to pull away from the wall 141, and create a better seal for retaining acid within the battery cells compartment.

For the shown surfaces, the internal surface 672 conically enlarges away from the center axis 692 moving away from the top surface 682 towards the bottom surface 676. The first fillet surface 674 has a fillet shape moving from the inside surface 672 to the bottom surface 676. The exterior surface 678 is cylindrical from the bottom surface 676 to the top surface 682, but for the labyrinth section 686. The stepped surface 680 includes a step wall 694 and a side wall 696 similar to what was discussed for FIG. 37.

Another variation from the bushing 600 to the bushing 605 is the inclusion of the reservoir surface 684. When the mini post 225 is inserted in the mini bushing 605, a reservoir 698 (best seen in FIG. 44) is created for mini post 225. That is, during the assembly process, excess soft or molten lead from the mini post 225 can flow and be deposited in the reservoir 698 created by the reservoir surface 684 and the mini post 224. As shown in FIG. 42, the reservoir surface 684 includes a first transition 700, a second transition 702, and a surface 704 between the first transition 702 and the second transition 702. The first transition 702 is shown as a second fillet surface. The second transition 702 is shown as a blended transition with a convex fillet and a concave fillet. Again, it is envisioned that the bushing 605 can include additional surfaces, may not include all of the shown surfaces, and/or may not be circular in shape (as viewed from the top or bottom or along a radial cross-section).

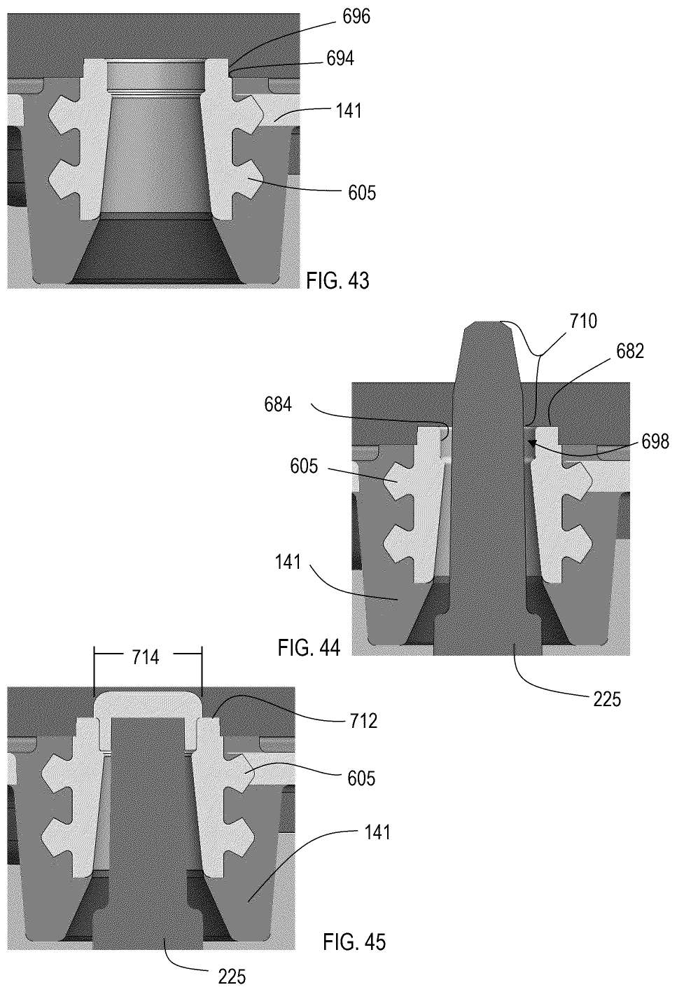

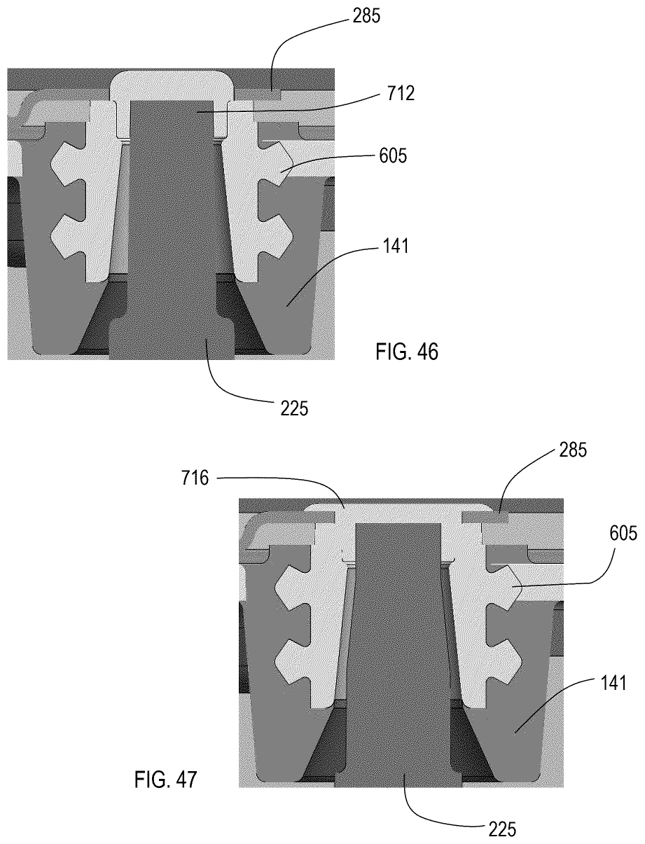

FIGS. 43-47 represent a process of attaching a ring connector 285 of a lead assembly 280 to a mini terminal post 225 and a mini bushing 605. FIG. 43 shows an example bushing (e.g., the mini bushing 605) after the mini bushing 605 has been molded into the wall 141. FIG. 44 shows the mini bushing 605 with a mini post 225 in place. The mini post 225 has material 710 above the top surface 682 of the bushing 605. The amount of material 710 extending above the bushing 605 is an amount sufficient for creating the process shown through the final weld of FIG. 46. Referring back to FIG. 44, the mini post 225 is heated to a temperature sufficient to deform and shape the mini-post 225. The mini-post 225 is modified into the form 712 shown in FIG. 45, which is generally “mushroom shaped”. Extra molten or soft material flows into the reservoir volume 698 or cavity created by the reservoir surface 684 and the mini-post 225. The form 712 has a diameter 714 small enough to receive the ring connector 285 as shown in FIG. 46. The form 712 also fixes the mini-post 225 to the mini bushing 605. During the heating process, the side wall 696 above the wall 141 creates a distance to reduce or prevent the heat from the mini post 225 and the mini bushing 605 from transferring from the mini bushing 605 to the wall 141. This limits the possibility of the wall 141 weakening or deforming from the heat. The offset created with the step wall 694 also provides a buffer for heat to transfer from the mini post 225 and the mini bushing 605 to the wall 141.

With reference to FIG. 46, the ring connector 285 is placed around the form 712 and onto the exterior surface of the bushing 605. The ring connector 285 is also placed on the mini bushing 605 and adjacent to the mini post 225. The form 712 is further heated to allow the form 712 to further soften or melt to the revised form 716 as shown in FIG. 47. The revised form 716 creates a weld over the connector ring, resulting in the ring connector 285 being fixed to the mini bushing 605 and the mini post 225. The mini post 225 and the mini bushing 605 create a seal to prevent any fluid (e.g., acid) from leaking through the mini post 225 and the mini bushing 605. The seal also helps with isolating the conductive ring from any fluid. FIG. 47 shows the cover after the lead frame/post weld into place.

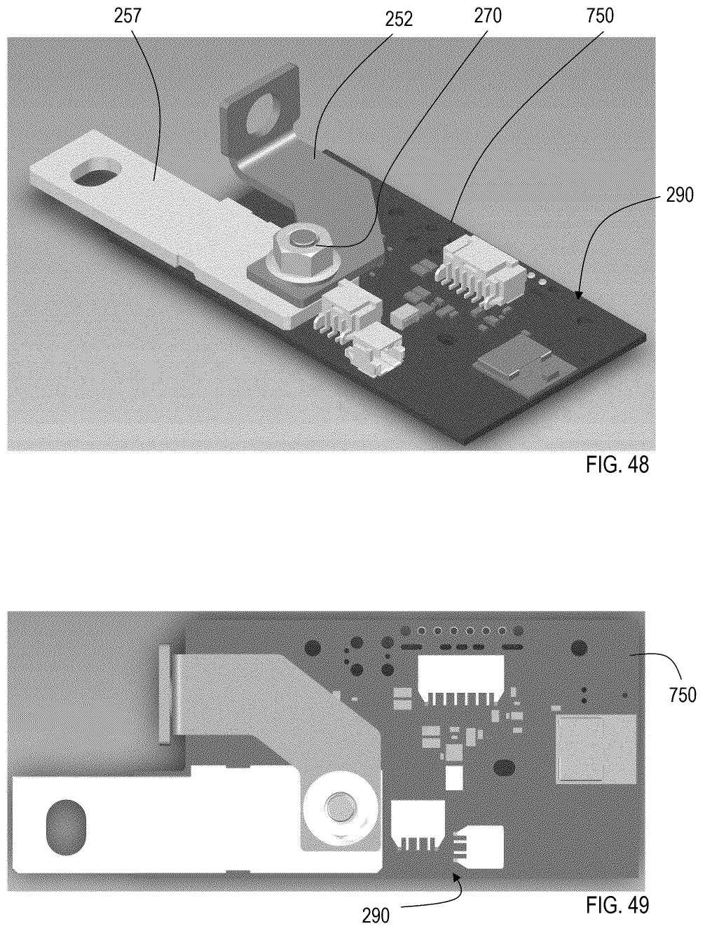

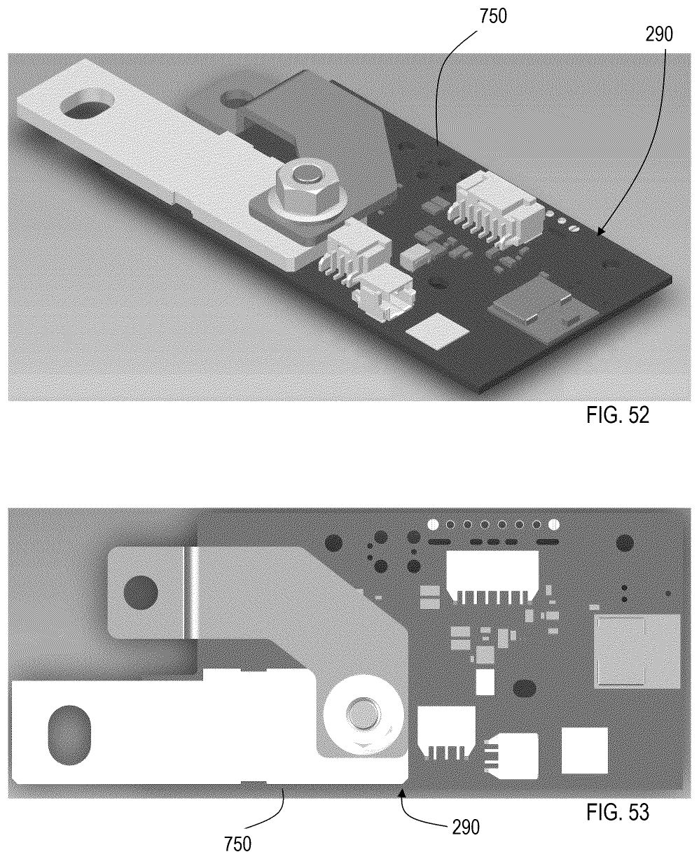

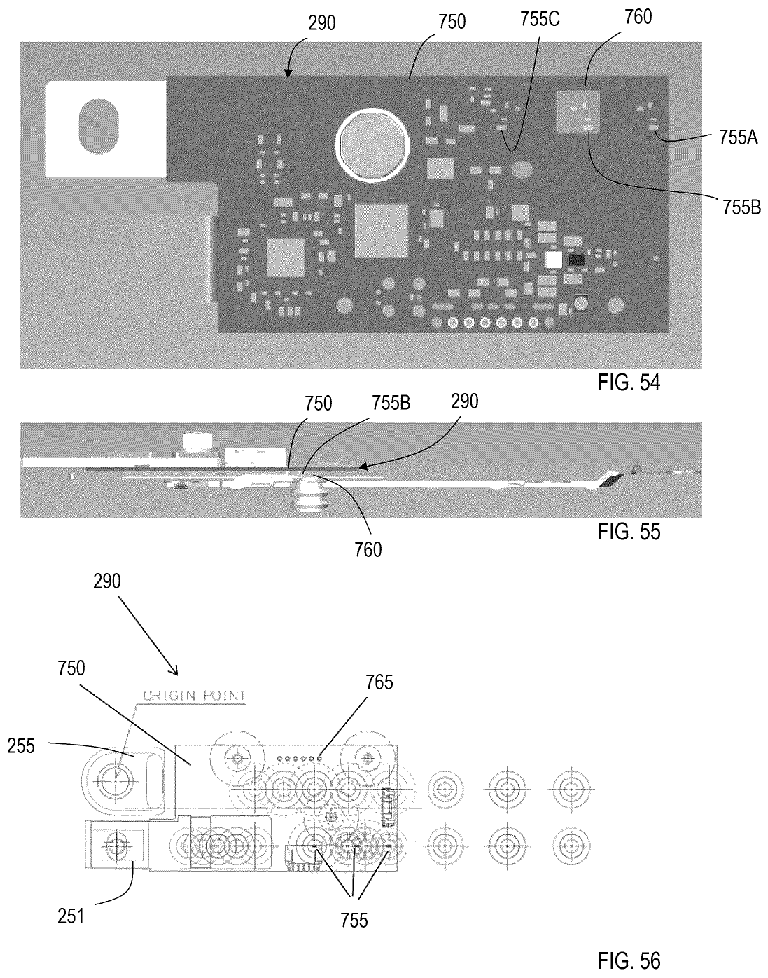

In FIGS. 48-51, the lead-acid battery system 100B includes a circuit board assembly, shown as a printed circuit board (PCB) assembly 290, having an integrated temperature sensing system. In FIGS. 52-55, the lead-acid battery system 100C includes a circuit board assembly, shown as a printed circuit board (PCB) assembly 290, having an integrated temperature sensing system. The example PCB assembly 290 may include a PCB 750, and one or more temperature sensors, such as thermistors 755A, 755B, and 755C (or collectively 755) mounted to the PCB 750. The thermistors 755A, 755B, and 755C monitor a battery cell temperature in the cells compartment 142 or an ambient temperature in the BMS compartment 143. The thermistors 755 are communicatively coupled to the processor 430 and the memory 435, discussed above. It should be appreciated that the battery system 100 includes additional sensors configured to monitor other operational parameters of the battery cells 145 and/or the battery system 100.

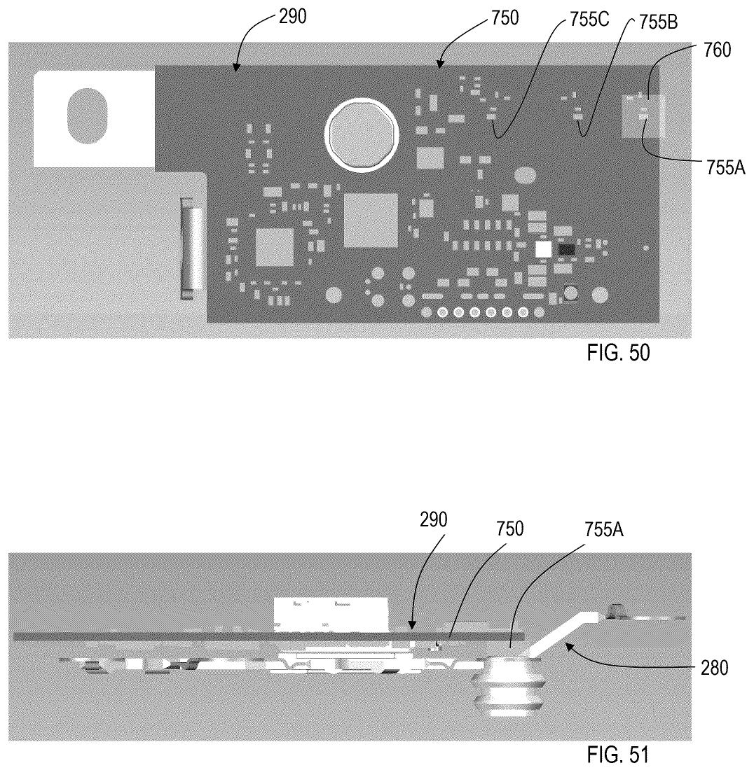

Referring now to FIGS. 50, 51, 54 and 55, the integrated temperature sensing system includes a thermal pad 760 (shown in phantom) positioned above a mini post 225. The thermal pad 760 in FIGS. 50 and 51 is shown connected to the thermistor 755A. The thermal pad 760 in FIGS. 51 and 52 is shown connected to the thermistor 755B. The thermal pad 760 may be provided thereon and between a thermistor 755 to electrically insulate the thermistor 755 from the connecting leads. The thermal pad 760 is thermally conductive to allow heat transfer to the thermistor 755 and may be constructed from an electrically insulating material. It is also envisioned that a different thermal conductor medium can be used in place of the thermal pad 760.

With reference to FIGS. 48-50 and FIGS. 52-54, the PCBs assemblies 290 are at least substantially identical. That is, the PCBs assemblies 290 are manufactured substantially identical and the PCB assemblies 290 can be programmed to or identify which sized battery system it is placed. For example, the lead assembly 280B for the PCB assembly 290B and the lead assembly 280C for the PCB assembly 290C receives the same BMS connector 286 at the same connection point 765.

Referring now to FIG. 56, the PCB 750 has three thermistors 755 mounted to a bottom surface of the PCB 750. This arrangement allows for a cell thermistor, 750A for FIGS. 51 and 750B for FIG. 55. The BMS ambient thermistor can be one of the other thermistors not coupled to the mini post. For example, thermistor 750C can be an ambient thermistor for both FIG. 51 and FIG. 55. It is envisioned that the third thermistor can provide a second ambient temperature or be deactivated. In alternative constructions, the PCB 750 may have only two thermistors or more thermistors.

The PCB assembly 290 may be configured to be operable with lead-acid batteries of various sizes, for example the H3 battery system 100B and the H6 battery system 100C discussed herein. FIG. 56 shows an example schematic for a PCB capable of being used with various sized batteries. As shown in the figure, thermistors 755 may be mounted in one or more locations corresponding to the locations of mini posts 225 extending into the BMS compartment 143.

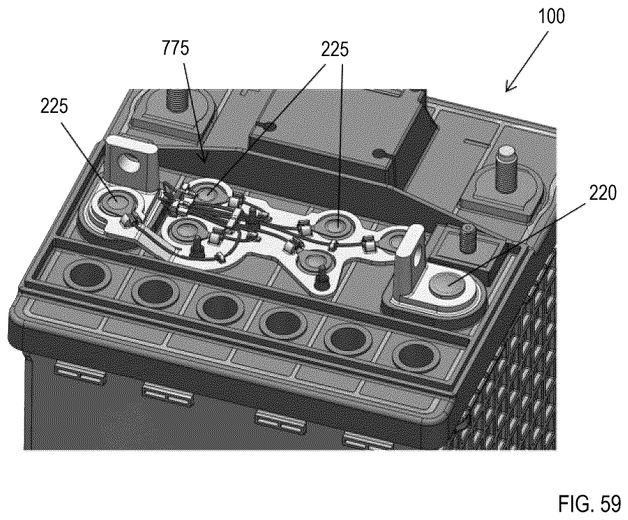

FIGS. 58 and 59 provide another example having a voltage harness. The voltage harness includes a frame assembly 775 with a snap-on frame 780 and flexible conductors 785. The flexible conductors 785 couple the mini posts 225 to the BMS (not shown).

Accordingly, this disclosure provides new and useful intelligent battery systems, new and useful components for intelligent battery systems, and new and useful methods of manufacturing and operating intelligent battery systems and components of the same.

Some of the systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. Some of the systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the maintenance conditions enabling the implementation of the methods described herein and which, when loaded in a processing system, is able to carry out these methods.

Furthermore, some arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or a suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using an appropriate medium, including but not limited to wireless, wireline, optical fiber, cable, RF, etc., or any suitable combination of the foregoing. Computer program code for carrying out operations for aspects of the present arrangements may be written in any combination of one or more programming languages. Instructions of the program code may be executed entirely at one location, or processor, or across multiple locations, or processors, as discussed herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

For the purpose of this disclosure, the term “coupled” means the joining of two members directly or indirectly to one another unless limited otherwise. Such joining may be stationary in nature or moveable in nature. Such joining may be achieved with the two members, or the two members and any additional intermediate members being integrally formed as a single unitary body with one another or with the two members or the two members and any additional intermediate members being attached to one another. Such joining may be permanent in nature or may be removable or releasable in nature.

The terms fixedly, non-fixedly, and removably, and variations thereof, may be used herein. The term fix, and variations thereof, refer to making firm, stable, or stationary. It should be understood, though, that fixed does not necessarily mean permanent-rather, only that a significant or abnormal amount of work needs to be used to make unfixed. The term removably, and variations thereof, refer to readily changing the location, position, station. Removably is meant to be the antonym of fixedly herein. Alternatively, the term non-fixedly can be used to be the antonym of fixedly.

Preferences and options for a given aspect, feature or parameter of the disclosure should, unless the context indicates otherwise, be regarded as having been disclosed in combination with any and all preferences and options for all other aspects, features, and parameters of the disclosure.

Aspects herein can be embodied in other forms without departing from the spirit or essential attributes thereof. Accordingly, reference should be made to the following claims, rather than to the foregoing specification, as indicating the scope hereof.

1. A lead assembly for a battery comprising a plurality of battery cells and a battery monitoring system, the lead assembly comprising:
a plurality of leads, each lead of the plurality of leads having a conductive path with a first end and a second end opposite to the first end, each first end comprising a first connector, each second end comprising a second connector, the first connector being couplable to a battery cell and the second connector being couplable to the battery monitoring system; and
a plurality of support connectors, each support connector of the plurality of support connectors coupling one lead of the plurality of leads with an adjacent lead of the plurality of leads.

2. The lead assembly of claim 1, wherein the plurality of leads consists essentially of a conductive material and the plurality of support connectors consists essentially of the conductive material.

3. The lead assembly of claim 1, further comprising:
a lead skeleton comprising the plurality of leads and the plurality of support connectors; and
a lead body enclosing a portion of the lead skeleton.

4. The lead assembly of claim 3, wherein the lead body encloses a portion of each lead of the plurality of leads.

5. The lead assembly of claim 3, wherein the lead body includes a plurality of apertures, wherein at least a portion of each support connector of the plurality of support connectors is exposed by a corresponding aperture of the plurality of apertures.

6. A battery comprising:
a plurality of battery cells;
a battery monitoring system; and
the lead assembly of claim 1 coupling the plurality of battery cells to the battery monitoring system.

7. A method of assembling a battery, the method comprising:
providing the lead assembly of claim 1, the lead assembly being a lead skeleton;
enclosing a portion of the lead skeleton with a lead body, the lead body includes a plurality of apertures, wherein the plurality of apertures includes an aperture corresponding to a respective support connector of the plurality of support connectors, and wherein the aperture corresponding to the respective support connector of the plurality of support connectors exposes at least a portion of the respective support connector from the lead body; and
breaking at least a portion of the plurality of support connectors in the plurality of apertures.

8. A lead assembly for a battery comprising a plurality of battery cells and a battery monitoring system, the lead assembly comprising:
a plurality of leads, each lead of the plurality of leads having a conductive path with a first end and a second end opposite to the first end, each first end comprising a first connector, each second end comprising a second connector, the first connector being couplable to a battery cell and the second connector being couplable to the battery monitoring system, wherein
the conductive path of at least one lead extends in a first respective direction in a first plane,
the conductive path of the at least one lead includes an intermediate conductive path having a bend changing the conductive path from the first respective direction to a respective intermediate direction, the conductive path extending in the respective intermediate direction, and
the intermediate conductive path having a bend changing the conductive path from the respective intermediate direction to a respective second direction, the conductive path extends in the respective second direction, the respective second direction being the same as the respective first direction and being in a second plane different from the first plane; and
a lead body enclosing a portion of each of the plurality of leads.

9. The lead assembly of claim 8, wherein the intermediate conductive path is internal to the lead body.

10. The lead assembly of claim 8, wherein the intermediate conductive path is external to the lead body.

11. The lead assembly of claim 8, wherein the intermediate conductive path is in the conductive path near the first connector of the at least one lead.

12. The lead assembly of claim 8, wherein the conductive path of each lead of the plurality of leads includes a respective intermediate conductive path.

13. The lead assembly of claim 8, wherein the bend changing the conductive path from the first respective direction to a respective intermediate direction is a first bend, the bend changing the conductive path from the respective intermediate direction to a respective second direction is a second bend.

14. The lead assembly of claim 13, wherein the first bend forms an obtuse angle, and the second bend forms the obtuse angle.

15. The lead assembly of claim 8, wherein the respective intermediate conductive path includes
a first bend changing the conductive path from the respective first direction to a respective third direction different from the respective first direction, the conductive path extends in the respective third direction,
a second bend changing the conductive path from the respective third direction to a respective fourth direction different from the respective third direction, the conductive path extends in the respective fourth direction, and
a third bend changing the conductive path from the respective fourth direction to the respective second direction different from the respective fourth direction, the conductive path extends in the respective second direction.

16. The lead assembly of claim 15, wherein the first bend forms an obtuse angle, the second bend forms an acute angle, and the third bend forms the obtuse angle.

17. The lead assembly of claim 15, wherein the second bend is a substantially U-shaped bend.

18. The lead assembly of claim 8, wherein the lead body includes a plurality of apertures.

19. The lead assembly of claim 18, wherein the lead assembly further comprises a plurality of support connectors, each support connector of the plurality of support connectors coupling one lead of the plurality of leads with an adjacent lead of the plurality of leads, wherein at least a portion of each support connector of the plurality of support connectors is exposed by a corresponding aperture of the plurality of apertures.

20. A battery comprising:
a plurality of battery cells;
a battery monitoring system; and
the lead assembly of claim 8 coupling the plurality of battery cells to the battery monitoring system.

21-96. (canceled)
